(19) United States
(12) Patent Application Publication
(10) Pub. No.: US 2026/0107688 A1
(43) Pub. Date: Apr. 16, 2026

(54) TEMPERATURE-SENSITIVE NEUROMORPHIC-BASED ACTUATOR-RESPONSIVE OPTICAL SKIN DEVICE AND ITS MANUFACTURING METHOD

(71) Applicant: UIF (University Industry Foundation), Yonsei University, Seoul (KR)

(72) Inventors: Cheol Min PARK, Seoul (KR); Seok Yeong LEE, Seoul (KR); Gwan Ho KIM, Goyang-si (KR); Woo Joong KIM, Seoul (KR); Ji Won KIM, Seoul (KR)

(73) Assignee: UIF (University Industry Foundation), Yonsei University, Seoul (KR)

(21) Appl. No.: 19/320,809

(22) Filed: Sep. 5, 2025

(30) Foreign Application Priority Data
Oct. 14, 2024 (KR) 10-2024-0139159

(51) Int. Cl. B25J 9/10

(52) U.S. Cl. CPC B25J 9/1075

(57) ABSTRACT

A temperature-sensitive transistor-actuator device and a method for manufacturing the same are disclosed. The temperature-sensitive transistor-actuator device comprises a semiconductor layer; a block copolymer layer formed on the semiconductor layer and having a lamella structure; an ion gel layer formed on the block copolymer layer; a source electrode contacting the semiconductor layer; a drain electrode spaced apart from the source electrode and contacting the semiconductor layer; and a gate electrode spaced apart from the source electrode and the drain electrode, applying a voltage to the semiconductor layer; a transistor part; a converter part electrically connected to the source electrode or the drain electrode; and an actuator part electrically connected to the converter part, having a bilayer structure of materials with differing degrees of contraction according to moisture content.

### CROSS-REFERENCE TO RELATED APPLICATION

This application claims priority from Korean Patent Application No. 10-2024-0139159 filed on Oct. 14, 2024 in the Korean Intellectual Property Office, and all the benefits accruing therefrom under 35 U.S.C. 119, the contents of which in its entirety are herein incorporated by reference.

### BACKGROUND

### Field

The present invention relates to a temperature-sensitive transistor-actuator device and a method for manufacturing the same. More specifically, the present invention relates to a temperature-sensitive neuromorphic-based actuator responsive optical skin device and a method for manufacturing the same.

### Description of Related Art

The development of artificial neural skin that mimics the information transmitted by sensory receptors in human skin in response to subtle changes in stimuli such as pressure, temperature, and humidity plays a significant role in human activity monitoring and personal health management applications, garnering considerable attention. The stimuli received from sensory receptors are often converted into electrical input signals, which are then transmitted to artificial synaptic devices such as memristors or field-effect transistor memories. Considering that these neural-transmitted synaptic output signals activate the muscles located beneath the skin, it is essential to develop a platform that integrates receptors, synapses, and artificial muscles to advance human-machine interface technology. In particular, synaptic devices that include ion channels, namely ion gel transistors, have been developed to better mimic human neural synaptic potentials induced by the movement of Ca²⁺ ions within the channel. When a gate field is applied to the transistor, the ions dissolved in the ion gel gate dielectric can generate an electrical potential between the source electrode and the drain electrode.

The color change of artificial neural skin in response to stimuli can extend the utility of the skin, providing the ability to dynamically visually monitor stimuli as well as shape and position recognition. In particular, inspired by various biological systems in nature that enable temperature-adaptive color changes, such as those found in octopuses, chameleons, and spiders, it may be useful to develop temperature-adaptive optical neural skin that can control synaptic performance according to temperature. Furthermore, by applying soft actuators to such temperature-adaptive optical neural skin, it is possible to realize temperature-adaptive muscle-coupled neural skin with visualization capabilities based on temperature.

### SUMMARY

The task that the present invention aims to solve is to present a technology that enables simultaneous visual feedback and control of soft actuators according to temperature changes. While existing artificial synapse-based devices primarily operate based on electrical signals, the present invention can provide more intuitive user feedback through temperature-responsive signal transmission and structural color changes. This characteristic has the potential to be applied in next-generation human-machine interface technology, offering advantages that can contribute to more precise environmental monitoring or personalized health management.

In one aspect, the invention provides a temperature-sensitive transistor-actuator device comprising: a semiconductor layer; a block copolymer layer formed on the semiconductor layer and having a lamella structure; an ion gel layer formed on the block copolymer layer; a source electrode contacting the semiconductor layer; a drain electrode spaced apart from the source electrode and contacting the semiconductor layer; and a gate electrode spaced apart from the source electrode and the drain electrode, applying a voltage to the semiconductor layer; a converter part electrically connected to the source electrode or the drain electrode; and an actuator part electrically connected to the converter part and having a bilayer structure of materials with differing degrees of contraction according to moisture content.

In one embodiment, the semiconductor layer may comprise PEDOT:PSS and MXene.

In one embodiment, the PEDOT:PSS and MXene included in the semiconductor layer may have a weight ratio of approximately 2:1 to 4:1.

In one embodiment, the on-off ratio of the semiconductor layer may be about 1.6 to 1.8.

In one embodiment, the block copolymer layer may comprise poly(styrene-block-2-vinyl pyridine) (PS-b-P2VP).

In one embodiment, the ion gel layer may comprise poly(N-isopropylacrylamide) (PNIPAM) and lithium bis(trifluoromethanesulfonimide) (Li⁺TFSI⁻).

In one embodiment, the bilayer structure of the actuator part comprises a first layer including PDMS and a second layer including PEDOT:PSS, and when moisture evaporates due to the Joule heat generated by the voltage applied to the second layer, it can bend in the direction of the second layer.

In one embodiment, the bilayer structure of the actuator part may have the second layer formed only on a portion of the first layer.

In another aspect, the present invention provides a method for manufacturing a temperature-sensitive transistor-actuator device, comprising: a semiconductor layer formed on a substrate; a source electrode contacting the semiconductor layer; and a drain electrode spaced apart from the source electrode and contacting the semiconductor layer; a semiconductor layer forming step for forming the semiconductor layer; a BCP forming step for forming a block copolymer layer having a lamella structure on the semiconductor layer; an ion gel forming step for forming an ion gel layer on the block copolymer layer; and a converter connection step for preparing an actuator part having a bilayer structure and electrically connecting it to the source electrode or the drain electrode via a converter part; further comprising a gate electrode forming step for forming a gate electrode that can apply a voltage to the semiconductor layer.

In one embodiment, the semiconductor layer may comprise PEDOT:PSS and MXene.

In one embodiment, the PEDOT:PSS and MXene included in the semiconductor layer may have a weight ratio of approximately 2:1 to 4:1.

In one embodiment, the block copolymer layer may comprise poly(styrene-block-2-vinyl pyridine) (PS-b-P2VP).

In one embodiment, the ion gel layer may comprise poly(N-isopropylacrylamide) (PNIPAM) and lithium bis(trifluoromethanesulfonimide) (Li⁺TFSI⁻).

In one embodiment, the bilayer structure of the actuator part may be prepared to comprise a first layer including PDMS and a second layer including PEDOT:PSS.

In one embodiment, the bilayer structure of the actuator part may form the second layer only on a portion of the first layer.

In one embodiment, the bilayer structure of the actuator part can be formed by stacking the first layer and the second layer, and then removing a portion to partially block the conductive path formed in the second layer, thereby extending the length of the conductive path.

Specifically, the present invention presents a temperature-adaptive neural-driven optical skin that combines a color-changing ion gel transistor and a soft actuator, enabling synaptic signal transmission, color change, and actuation in response to temperature. First, a synaptic ion gel transistor with thermoresponsive color was developed by mixing a poly(3,4-ethylenedioxythiophene): poly(styrenesulfonic acid) (PEDOT:PSS) semiconductor channel with two-dimensional (2D) titanium carbide (Ti₃C₂Tₓ) MXene. An ion gel gate insulator composed of a thermoresponsive poly(N-isopropylacrylamide) (PNIPAM) and lithium bis(trifluoromethanesulfonyl)imide (Li⁺TFSI⁻) mixture was stacked on a one-dimensional (1D) block copolymer (BCP) photonic crystal (PC). The structural color of the BCP PC reversibly and stably changes from 20° C. to 60° C., and the ion concentration within the channel is controlled by the thermoresponsive BCP, resulting in the synaptic operation of the device varying with temperature.

A temperature-adaptive display synapse (TADS) with a Joule heater in a 3×3 array has been developed, where each pixel provides structural colors and synaptic outputs that respond to temperature. Additionally, the TADS is connected to a bilayer soft actuator composed of PEDOT:PSS and poly(dimethylsiloxane) (PDMS) elastomer through a current-voltage converter. The actuator exhibits bending from 4 degrees to 27.5 degrees depending on the temperature, forming a temperature-adaptive optical neural-driven skin as the temperature changes from 20° C. to 60° C.

The effect of the present invention can provide intuitive visual feedback to the user by simultaneously utilizing synaptic signals and color changes in response to temperature variations. Furthermore, such structural changes can influence not only signal transmission but also the movement of the actuator, allowing for efficient operation in various environments. This demonstrates the potential for application in next-generation wearable devices or customized health management systems, and furthermore, it can contribute to enhancing the user experience.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1A is a schematic of a biological system controlled by pre-and post-synaptic signals from nerves and muscles (upper diagram), and a schematic of the temperature-adaptive neuro-actuating optical skin composed of TADS connected through a microprocessor and a bilayer soft actuator, along with a schematic of the insertion of the MXene/PEDOT:PSS semiconductor channel layer in the TADS (lower diagram).

FIG. 1B is a photo showing structural colors appearing in red, green, and blue at 20° C., 40° C., and 60° C., respectively, at the top of the TADS as a temperature-adaptive neuro-actuating optical skin (scale: 5 mm).

FIG. 1C is a cross-sectional FIB-SEM image of TADS (left, scale: 1 μm) and an enlarged TEM image of the MXene/PEDOT:PSS composite layer of TADS on a glass substrate (right, scale: 10 nm).

FIG. 2A is an analysis of the MXene/PEDOT:PSS semiconductor channel layer of TADS, illustrating the signal transmission process between the pre-and post-neurons through TADS.

FIG. 2B is the synaptic current (PSC) profile of TADS using the MXene/PEDOT:PSS (1:3) semiconductor channel under −3 V gate pulse for 50 cycles (VSD=−0.01 V, Δt=0.5 s).

FIG. 2C is a graph summarizing the synapse ON/OFF current ratio of TADS measured in the PEDOT:PSS semiconductor channel layer according to the weight percentage of MXene under the same conditions as FIG. 2B.

FIG. 2D is the XPS O 1s spectra of MXene, MXene/PEDOT:PSS, and PEDOT:PSS films, with the red arrows indicating the change in binding energy due to the bonding between O-S and PEDOT in the MXene/PEDOT:PSS film.

FIG. 2E is the FT-IR spectra of MXene, MXene/PEDOT:PSS, and PEDOT:PSS films.

FIG. 2F is the HR-XRD pattern of the MXene/PEDOT:PSS semiconductor channel layer of TADS, where the arrows indicate the peak positions altered by the bonding between MXene and PEDOT:PSS.

FIG. 3A is the synaptic current (PSC) profile of TADS at room temperature (20° C.) after long-term potentiation (LTP)/long-term depression (LTD) with a gate voltage of −3 V (VSD=−0.01 V, Δt=0.3 s) according to the number of pulses.

FIG. 3B is the pulse number dependence plasticity (SNDP) index at room temperature (20° C.), calculated from the PSC intensity ratio between the first pulse and the nth pulse in FIG. 3A.

FIG. 3C is the PPF index of TADS at room temperature (20° C.) (−3 V gate pulse) as a function of the interval time between two spikes (VSD=−0.01 V), represented as (A2/A1×100%).

FIG. 3D is the PSC profile of TADS at room temperature (20° C.) under 50 gate pulses at different gate voltages (from −0.5 V to −3 in 0.5 V increments, VSD=−0.01 V, Δt=0.3 s).

FIG. 3E is the PSC cycle curves of TADS at room temperature (20° C.) representing LTP and LTD during three different gate voltage sequences (−1 V/+0.5 V, −2 V/+1 V, −3 V/+1.5 V) with a gate pulse duration of 0.06 seconds (Δt=0.3 s).

FIG. 3F is the PSC cycle results of TADS at room temperature (20° C.). The left diagram shows LTP/LTD durability consisting of 50 pulses at −3 V and 50 pulses at +1.5 V repeated 80 times (8000 pulses total, VSD=−0.01 V, Δt=0.3 s). The right diagram highlights the PSC profile during pulses from 4000 to 4500.

FIG. 4A is a photograph showing the structural color of the ion gel/BCP bilayer film under temperature conditions ranging from 20° C. to 60° C. (scale: 1 cm).

FIG. 4B is a diagram showing the ion movement of Li⁺TFSI⁻ in the ion gel/BCP bilayer due to the sol-gel transition of the ion gel and water evaporation, as well as the expansion/contraction of QP2VP.

FIG. 4C is a graph showing the lamella periodicity values measured by GISAXS and the maximum reflection wavelength values of the ion gel/BCP PC film measured by UV-visible spectroscopy, indicating variations with temperature.

FIG. 4D is a graph showing the azimuthal scattering intensity according to the scattering vector q, represented by the 1D SAXS plot at 20° C. (black: initial room temperature before heating cycle, red: result after heating to 60° C. and then cooling).

FIG. 4E is the Nyquist plot showing the EIS results of TADS in a temperature range from 20° C. to 60° C.

FIG. 4F is the PCS curve of TADS measured after 50 gate pulses (VG=−3 V, VDS=−0.01 V, Δt=0.3 s).

FIG. 4G is a graph showing the change in the synapse ON/OFF ratio of TADS measured at 10° C. intervals from 20° C. to 60° C.

FIG. 4H is a graph showing the reliable synapse ON/OFF ratio of TADS at three different temperatures (20° C., 40° C., 60° C.) (50 gate pulses, VG=−3 V, VDS=−0.01 V, Δt=0.3 s). The red, green, and blue areas schematically represent the structural color of TADS at the corresponding temperatures.

FIG. 5A is a schematic of pixelated TADS using a Cr/Au electro-thermal converter as a pixel array of TADS, structured to be used as a Joule heater.

FIG. 5B is a graph showing the temperature change of the converter as a function of the voltage applied, and the change in the maximum reflection wavelength value of TADS according to the voltage applied to the converter.

FIG. 5C is a photo showing the structural color changes of the pixels ((1,1) blue, (2,2) green, (3,3) red) depending on the voltage applied to the converter ((1,1) 5 V, (2,2) 3 V, (3,3) 1 V) (scale: 1 cm).

FIG. 5D is an example showing that the structural color and synapse ON/OFF ratio of each pixel can be controlled in the 3×3 array of TADS and the converter. The left 3D graphs show the synapse ON/OFF ratio of each pixel, the photos show the temperature-controlled structural color information, and the infrared images show the temperature distribution in the array (scale: 1 cm).

FIG. 6A is a signal processing diagram of a temperature-adaptive neural-driven optical skin including TADS and a bilayer soft actuator, wherein the temperature-dependent PSC of TADS is converted into an amplified voltage to operate the bilayer soft actuator.

FIG. 6B is a graph showing the relationship between the input PSC generated from TADS and the output voltage converted from the amplifier at 20° C., 40° C., and 60° C. (VG=−1 V, 100 pulses, VSD=−0.01 V, Δt=0.2 s).

FIG. 6C is a set of photographs showing the bending angle changes of the soft actuator controlled by TADS at 20° C., 40° C., and 60° C. The small top image represents the temperature distribution of the soft actuator observed by IR camera. The small bottom images show the structural colors of TADS (red, green, blue) at each temperature (scale: 1 cm).

FIG. 6D is a graph representing the converted voltage of the bilayer actuator according to the temperature of the TADS.

FIG. 6E is a graph showing the bending angle of the bilayer actuator according to the temperature of the TADS.

FIG. 7A is a schematic for the fabrication of TADS, including a substrate with metal electrodes defined by photolithography and an MXene-based channel, followed by the deposition of an ion gel.

FIG. 7B is a schematic for the fabrication of TADS, illustrating the photolithography process for creating a metal electrode and an MXene-based channel on a substrate.

FIG. 8A is a TEM image showing a cross-sectional analysis of the BCP PC layer expanded with Li⁺TFSI⁻ (scale: 200 nm).

FIG. 8B is an EDS mapping image of the PS-b-QP2VP layer expanded with Li⁺TFSI⁻, showing the atomic spectra of Si, C, N, F, Br, and O (scale: 100 nm).

FIG. 9A is a TEM image showing a cross-sectional analysis of the BCP PC layer contracted without Li⁺TFSI⁻.

FIG. 9B is an EDS mapping image of the PS-b-QP2VP layer contracted without Li⁺TFSI⁻, showing the atomic spectra of Si, C, N, F, Br, and O.

FIG. 10 is a transfer curve of TADS with MXene/PEDOT:PSS channel (1:3), where the gate voltage varies from 1 V to −3 V.

FIG. 11A is the PSC operation of TADS prepared with a weight ratio of 0% MXene in the MXene/PEDOT:PSS channel (VG=−3 V, 50 pulses, VSD=+0.01 V, Δt=0.5 s).

FIG. 11B is the PSC operation of TADS prepared with a weight ratio of 9.1% MXene in the MXene/PEDOT:PSS channel (VG=−3 V, 50 pulses, VSD=+0.01 V, Δt=0.5 s).

FIG. 11C is the PSC operation of TADS prepared with a weight ratio of 16.6% MXene in the MXene/PEDOT:PSS channel (VG=−3 V, 50 pulses, VSD=+0.01 V, Δt=0.5 s).

FIG. 11D is the PSC operation of TADS prepared with a weight ratio of 25% MXene in the MXene/PEDOT:PSS channel (VG=−3 V, 50 pulses, VSD=+0.01 V, Δt=0.5 s).

FIG. 11E is the PSC operation of TADS prepared with a weight ratio of 50% MXene in the MXene/PEDOT:PSS channel (VG=−3 V, 50 pulses, VSD=+0.01 V, Δt=0.5 s).

FIG. 12A is the XPS analysis of MXene, PEDOT:PSS, and MXene/PEDOT:PSS films, showing the full-range XPS spectra of MXene (top), PEDOT:PSS (middle), and MXene/PEDOT:PSS (bottom).

FIG. 12B is the fitted XPS spectrum for the C 1s core level of MXene, PEDOT:PSS, and MXene/PEDOT:PSS films.

FIG. 12C is the fitted XPS spectrum for the Ti 2p core level of MXene, PEDOT:PSS, and MXene/PEDOT:PSS films.

FIG. 12D is the fitted XPS spectrum for the S 2p core level of MXene, PEDOT:PSS, and MXene/PEDOT:PSS films.

FIG. 12E is the fitted XPS spectrum for the F 1s core level of MXene, PEDOT:PSS, and MXene/PEDOT:PSS films.

FIG. 13A is a cycling curve between LTP and LTD, showing the curves for different pulse counts at a gate voltage of −1 V/+0.5 V with a pulse duration of 0.06 s.

FIG. 13B is a cycling curve applying 30 gate pulses with pulse durations varying from 0.06 s to 0.14 s.

FIG. 14A is a photograph showing the structural color change of the ion gel/block copolymer bilayer according to temperature in the range of 20° C. to 60° C. (scale bar: 1 cm).

FIG. 14B is the reflection spectrum of the bilayer film measured using a UV-visible spectrometer, showing the structural color of the film according to temperature.

FIG. 14C is a graph plotting the structural color results of the ion gel/block copolymer bilayer film in the CIE color space according to temperature.

FIG. 15A is a photograph showing the transparency of the ion gel film as a function of the sol-gel phase transition due to temperature changes (scale bar: 1 cm).

FIG. 15B is a graph showing the transmittance of the ion gel film measured at 550 nm, significantly increasing at approximately 40° C.

FIG. 15C is a DSC curve showing an endothermic peak at 48.05° C. due to the sol-gel transition during heating from 25° C. to 80° C.

FIG. 15D is the FT-IR spectrum of the PNIPAM/Li⁺TFSI⁻ ion gel film measured in the range of 1400-3700 cm⁻¹.

FIG. 16A is a photograph of the BCP PC film encapsulated with a PDMS film.

FIG. 16B is a photograph showing the structural colors of encapsulated BCP PC film at various temperatures (scale bar: 1 cm).

FIG. 17 is the change in structural color of the BCP photonic crystal film over time at a constant temperature (scale: 1 cm).

FIG. 18A is a photograph showing the structural color change of the stacked BCP PC film due to heating and cooling of the PNIPAM/Li⁺TFSI⁻ mixed film (scale: 0.5 cm).

FIG. 18B is a graph showing the change in maximum reflection wavelength according to heating and cooling temperatures of the stacked BCP PC film with PNIPAM/Li⁺TFSI⁻ mixed film.

FIG. 19 is the structural color change of BCP PC film over time under various humidity conditions (scale: 1 cm).

FIG. 20A is the 2D transmission SAXS patterns of the ion gel/block copolymer bilayer from 20° C. to 60° C. and after cooling back to 20° C.

FIG. 20B is a 1D SAXS scattering intensity graph of the ion gel/block copolymer bilayer, based on qz, obtained from the 2D pattern. The arrows indicate the scattering peaks of each graph.

FIG. 20C is a graph showing the relationship between the lamella period of the BCP PC film and temperature in terms of 2π/qz (nm).

FIG. 21A is the PSC curve of TADS measured at 30° C. with a −3 V input gate voltage (VSD=−0.01 V), varying the spike number from 1 to 100 pulses.

FIG. 21B is the PSC curve of TADS measured at 40° C. with a −3 V input gate voltage (VSD=−0.01 V), varying the spike count from 1 to 100 pulses.

FIG. 21C is the PSC curve of TADS measured at 50° C. with a −3 V input gate voltage (VSD=−0.01 V), varying the number of spikes from 1 to 100 pulses.

FIG. 21D is the PSC curve of TADS measured at 60° C. with a −3 V input gate voltage (VSD=−0.01 V), varying the spike count from 1 to 100 pulses.

FIG. 22A is the PPF index value measured at 30° C. with a −3 V gate voltage applied at various time intervals between the first and second gate pulses (VSD=−0.01 V).

FIG. 22B is the PPF index value measured at 40° C. with a −3 V gate voltage applied at various time intervals between the first and second gate pulses (VSD=−0.01 V).

FIG. 22C is the PPF index value measured at 50° C. with a −3 V gate voltage applied at various time intervals between the first and second gate pulses (VSD=−0.01 V).

FIG. 22D is the PPF index value measured at 60° C. with a −3 V gate voltage applied at various time intervals between the first and second gate pulses (VSD=−0.01 V).

FIG. 23A is a photograph of the flexible TADS fabricated on a PET substrate and the results of PSC operation at 20° C.

FIG. 23B is a photograph of the flexible TADS fabricated on a PET substrate and the results of PSC operation at 40° C.

FIG. 23C is a photograph of the flexible TADS fabricated on a PET substrate and the results of PSC operation at 60° C.

FIG. 24 is the TADS including an electro-thermal conversion device. The pixelated TADS above the conversion device converts electrical energy into thermal energy. The left diagram shows TADS at room temperature without applying a DC voltage to the conversion device, exhibiting a red structural color, while the right diagram shows TADS at 60°C. with a 5 V DC voltage applied, exhibiting a blue structural color.

FIG. 25A is a photograph showing the structural color change of TADS attached to the arm skin at room temperature.

FIG. 25B is a photograph showing the structural color change of TADS attached to the arm skin at 40° C.

FIG. 26 is a circuit diagram for operating the soft actuator by converting the PSC of TADS into an amplified voltage.

FIG. 27A is the output voltage converted from the PSC of TADS and the amplifier under 100 pulses with VG=−1 V (VSD=−0.01 V, Δt=0.2 s), measured at a relative humidity (RH) of 60%.

FIG. 27B is the output voltage converted from the PSC of TADS and the amplifier under 100 pulses with VG=−1 V (VSD=−0.01 V, Δt=0.2 s), measured at RH 75% and 25° C.

### DETAILED DESCRIPTIONS

Hereinafter, a detailed description of the embodiments of the present invention will be provided with reference to the attached drawings. The present invention may undergo various modifications and can take on various forms; therefore, specific embodiments are illustrated in the drawings and described in detail in the text. However, this is not intended to limit the present invention to the specific disclosed forms, and it should be understood that all modifications, equivalents, or alternatives included within the spirit and technical scope of the present invention are encompassed. Similar reference numerals have been used for similar components while describing each drawing. In the attached drawings, the dimensions of the structures are shown enlarged for the sake of clarity of the present invention.

The terms used in this application are employed solely for the purpose of describing specific embodiments and are not intended to limit the present invention. Singular expressions shall include plural expressions unless the context clearly indicates otherwise. In this application, terms such as “comprising” or “having” are intended to specify the existence of features, numbers, steps, actions, components, or combinations thereof as described in the specification, and should not be understood as excluding the presence or potential addition of one or more other features, numbers, steps, actions, components, or combinations thereof. In the context of this specification, the term “about” may refer to approximately ±1%, ±2%, ±3%, ±4%, ±5%, ±6%, ±7%, ±8%, ±9%, or ±10% of the values specified in the specification.

In addition, the description of one aspect of the present invention may be similarly applied to the same or similar configurations or terms described in other aspects.

Unless otherwise defined, all terms used herein, including technical or scientific terms, shall have the same meaning as understood by a person of ordinary skill in the relevant technical field to which the present invention pertains. Terms that are defined in commonly used dictionaries should be interpreted to have meanings consistent with the context of the relevant technology, and unless explicitly defined in this application, they shall not be interpreted in an idealized or overly formal manner.

The temperature-sensitive transistor-actuator device according to an embodiment of the present invention comprises: a semiconductor layer; a block copolymer layer formed on the semiconductor layer and having a lamella structure; an ion gel layer formed on the block copolymer layer; a source electrode contacting the semiconductor layer; a drain electrode spaced apart from the source electrode and contacting the semiconductor layer; and a gate electrode spaced apart from the source electrode and the drain electrode, applying a voltage to the semiconductor layer; a transistor part comprising the above; a converter part electrically connected to the source electrode or the drain electrode; and an actuator part electrically connected to the converter part and having a bilayer structure of materials with different degrees of contraction according to moisture content; thereby providing a temperature-sensitive transistor-actuator device.

The role of the semiconductor layer is to provide an electron transport pathway. This semiconductor layer can control conductivity while an electrical signal flows from the source electrode to the drain electrode. When a specific voltage is applied to the gate electrode, a change in conductivity occurs, which can affect the operation of the transistor device. The semiconductor layer is a key component that controls the main functions of the device and has the potential to respond sensitively to temperature changes or environmental conditions. This allows the device to maintain stable performance under various conditions.

As long as the aforementioned functions are performed, the material of the semiconductor layer is not specifically limited. In one embodiment, the semiconductor layer may comprise PEDOT:PSS and MXene. In the context of this specification, PEDOT:PSS refers to a conductive polymer composite made of poly(3,4-ethylenedioxythiophene)-polystyrenesulfonic acid. PEDOT is a material that possesses electrical conductivity, facilitating electron transport, while PSS serves to stabilize PEDOT and improve its processability. The combination of these two components can provide excellent conductivity and flexibility, making it widely used in various electronic devices. Additionally, PEDOT:PSS is suitable for solution processing, making it easy to manufacture large-area devices. In the context of this specification, MXene refers to materials in the titanium carbide (Ti₃C₂Tₓ) family that have a two-dimensional structure. MXene possesses high electrical conductivity and metallic properties, and can have various surface functional groups, making it advantageous for interactions with other materials. Due to these characteristics, MXene has the potential to be utilized as an important semiconductor material in electronic devices such as transistors.

In one embodiment, the PEDOT:PSS and MXene included in the semiconductor layer may have a weight ratio of approximately 2:1 to 4:1. In one embodiment, the PEDOT:PSS and MXene included in the semiconductor layer may have a weight ratio of approximately 3:1. In one embodiment, when the PEDOT:PSS and MXene included in the semiconductor layer have a weight ratio of approximately 3:1, the on-off ratio of the transistor may be optimized. At this weight ratio, the interaction between MXene and PEDOT:PSS occurs most efficiently, increasing the conductivity of the device while significantly enhancing the current change with respect to voltage (i.e., the current difference between the on state and the off state). In particular, an excessive amount of MXene may lead to too high conductivity, resulting in an increase in current in the off state; however, at a weight ratio of 3:1, an appropriate balance can be achieved to maintain a high on-off ratio. This may provide advantages in terms of signal amplification and electrical control of the device. In one embodiment, the on-off ratio of the semiconductor layer may be approximately 1.6 to 1.8.

In the context of this specification, the dictionary definition of a lamella structure refers to a polymer material that has a repetitive layered structure. This structure is formed by two or more different types of polymer blocks arranged in a regular pattern, which can exhibit various responses depending on the physical properties of each layer. The lamella structure can induce structural color changes through the interference of light or demonstrate reactivity by rearranging in response to external stimuli. These characteristics may possess the potential to assist in various functional elements such as signal transmission or color change in electronic devices.

In the context of this specification, the literal meaning of block copolymer refers to a polymer substance in which two or more different monomers are repetitively connected. Each block possesses different physical and chemical properties, and due to these heterogeneous characteristics, they can be regularly arranged under specific conditions to form unique nanostructures. Block copolymers can utilize their structural properties to respond to external factors such as temperature and humidity, and they may perform functional roles in various devices.

The role of the block copolymer layer is to induce structural color changes in the device in response to external temperature variations. The lamella structure of the block copolymer layer can reversibly rearrange according to temperature changes, resulting in variations in the reflectance of light at specific wavelengths. These structural characteristics can help the device respond sensitively to temperature and provide visual feedback. Additionally, this block copolymer layer can interact with other layers to play a significant role in the overall performance of the device.

As long as the aforementioned functions are performed, the material of the block copolymer layer of the lamella structure is not specifically limited. In one embodiment, the block copolymer layer may comprise poly(styrene-block-2-vinyl pyridine) (PS-b-P2VP). PS-b-P2VP consists of two different blocks, polystyrene (PS) and polyvinylpyridine (P2VP), which can form a regular lamella structure. This structure can induce structural color changes as the interactions between the blocks change in response to external stimuli such as temperature and humidity. In particular, PS-b-P2VP may cause reversible structural changes, making it potentially suitable for temperature-responsive displays or sensor applications.

In the context of this specification, the literal meaning of ion gel refers to a gel-like substance that contains ions. Ion gels generally possess conductivity and can respond sensitively to electrochemical reactions. This substance has characteristics such as conductivity, flexibility, and permeability, and can alter its physical and electrical properties under various environmental conditions. Ion gels have the potential to be used as key components in devices such as transistors or actuators.

The role of the ion gel layer is to facilitate ion movement within the device and control conductivity. The ion gel layer can change its physical properties according to temperature variations, thereby allowing for the regulation of the flow of electrical signals or the responsiveness of the device. Additionally, the ion gel layer can interact with the block copolymer layer to induce functional changes such as color variation of the device or synaptic operations. This process can help the device respond flexibly to environmental changes.

As long as the aforementioned functions are performed, the material of the ion gel layer is not specifically limited. In one embodiment, the ion gel layer may comprise poly(N-isopropylacrylamide) (PNIPAM) and lithium bis(trifluoromethanesulfonimide) (Li⁺TFSI⁻). PNIPAM has the characteristic of undergoing a reversible sol-gel transition depending on temperature, exhibiting contraction above a certain temperature and expansion upon cooling. Additionally, Li⁺TFSI⁻ can provide ionic conductivity, enhancing the electrical performance of the ion gel layer. This combination can lead to variations in conductivity and physical properties with temperature changes, significantly affecting the electrical and structural characteristics of the device. In particular, the ion gel layer can assist in inducing conductivity and visual feedback in temperature-responsive devices.

When the temperature increases in the transistor part of the device of the present invention, the ion gel layer undergoes a sol-gel transition phenomenon, which may result in changes in the mobility of ions and electrical conductivity. As the temperature rises, the electrical conductivity of the ion gel layer may decrease, which is due to the ion gel becoming more transparent at higher temperatures, leading to a reduction in ion concentration. At the same time, the state change of the ion gel layer also affects the lamella structure of the block copolymer layer, resulting in a structural color change. In this process, the color generally shifts towards a more bluish tone, thereby providing visual feedback regarding the temperature change of the device.

Conversely, when the temperature decreases in the transistor part of the device of the present invention, the ion gel layer can revert to a gel state, thereby increasing ion mobility. As the ion gel becomes denser, the concentration of ions increases, which may lead to an increase in electrical conductivity. Additionally, the change in the physical state of the ion gel layer can also affect the lamella structure of the block copolymer layer, potentially shifting the structural color towards a more reddish tone. Such changes enable the device to provide visual feedback at lower temperatures, and the functional responsiveness of the device may also be enhanced.

The roles of the source electrode, drain electrode, and gate electrode are to input, control, and ultimately output electrical signals. The source electrode serves to receive signals from the outside and transmit them to the semiconductor layer, while the drain electrode receives the signals and ultimately conveys them to the external circuit. The gate electrode functions to regulate the flow of signals through the voltage applied to the semiconductor layer. Each electrode can assist in precisely controlling the operation of the device and plays an important role in regulating electrical responses.

The effect of the voltage applied to the gate electrode in the transistor part of the device of the present invention on the electrical behavior of the device is as follows: When a voltage is applied to the gate electrode, ions in the ion gel layer move to the semiconductor layer, resulting in a change in the concentration of charge carriers. In this process, the current flow between the source electrode and the drain electrode is regulated, and the conductivity may also change. As the voltage increases, more current may flow within the semiconductor layer, potentially enhancing the conductivity of the device, which can be an important factor in controlling the overall performance of the device.

The role of the transistor part is to amplify or convert the input electrical signals to control the various functions of the device. The transistor part is composed of a semiconductor layer and electrodes, and it can sensitively respond to temperature changes or voltage to control the signal transmission speed and strength. This can help optimize the overall performance and efficiency of the device. The transistor part plays a particularly important role in connecting to the actuator to induce operation.

The role of the converter part is to convert and amplify the current signals transmitted from the source electrode or drain electrode into voltage signals. The converter part can efficiently convert the current and adjust it to the voltage level required by other components of the device, thereby enhancing the performance of the device. Additionally, the converter part can deliver the amplified voltage signals to the actuator part, enabling more precise control.

The role of the actuator part is to induce physical movement by utilizing contraction and expansion according to moisture content. The actuator part, which is composed of a bilayer structure, has bending or moving characteristics by using materials that react differently to temperature changes. Such movement allows for visual feedback or operation of the device to be confirmed externally, providing the potential for application in various fields.

In one embodiment, the bilayer structure of the actuator part comprises a first layer including PDMS and a second layer including PEDOT:PSS. When a voltage is applied to the second layer, the moisture in the PEDOT:PSS layer evaporates due to the Joule heat generated, resulting in a contraction phenomenon that allows the actuator to naturally bend in the direction of the second layer. This bending can be adjusted according to the magnitude of the voltage and the duration of application, thereby enabling control of the movement of the device or performing functions that respond to external stimuli. The bilayer structure provides the potential to implement precise operations in various application fields through physical deformation in response to voltage.

In the context of this specification, the dictionary definition of Joule heat refers to the heat generated due to the resistance of a conductive material when an electric current flows through it. This can be explained as a phenomenon where the charges within the material encounter resistance as the current flows, resulting in the conversion of kinetic energy into thermal energy. Joule heat is generated in proportion to the magnitude of voltage and current, and this heat can serve as an energy source that can be utilized in various electronic devices that convert electrical signals into physical deformations.

In one embodiment, the bilayer structure of the actuator part may have the second layer formed only on a portion of the first layer. In the context of this specification, the dictionary definition of “portion” refers to a part or segment of the whole. It is used to denote a specific area or section and serves to distinguish areas where specific functions or structures are applied intensively. “Portion” can represent a divided part based on physical components or functional roles, and it may refer to a specific region capable of performing differentiated functions within the overall device or structure.

For example, the second layer may cover the first layer without completely covering it, leaving a portion of the center in a “U” shape, while maintaining an overall conductive path. This structure allows Joule heat to be generated uniformly across the entire area, rather than being limited to specific parts, when current flows. This enables the overall thermal distribution of the device to be kept uniform, while also allowing bending or deformation to occur throughout the entire structure rather than being confined to specific regions. Such a design provides the possibility of implementing the operation of the actuator more consistently.

After forming a bilayer structure, it is easy to remove a portion of the center to create a “U” shape, which is provided as an example; however, the form of expanding the conductive path over the entire area of the actuator part is not specifically limited to the “U” shape as described above. Other non-restrictive examples of shapes may include “O” or “C” shapes. Additionally, lattice or spiral structures can also be considered as examples that can form conductive paths while evenly generating Joule heat. These various forms can be modified according to specific design requirements or application environments of the device, contributing to the optimization of the functionality and efficiency of the actuator.

Meanwhile, the method for manufacturing a temperature-sensitive transistor-actuator device according to an embodiment of the present invention includes a semiconductor layer formed on a substrate; a source electrode contacting the semiconductor layer; and a drain electrode spaced apart from the source electrode and contacting the semiconductor layer; a semiconductor layer forming step for forming the semiconductor layer; a BCP forming step for forming a block copolymer layer having a lamella structure on the semiconductor layer; an ion gel forming step for forming an ion gel layer on the block copolymer layer; and a converter connection step for preparing an actuator part having a bilayer structure and electrically connecting it to the source electrode or the drain electrode via a converter part; and further includes a gate electrode forming step for forming a gate electrode that can apply a voltage to the semiconductor layer.

The role of the semiconductor layer forming step is to provide a basic conductive path for the device. The semiconductor layer serves as a key material for transmitting electrical signals between the source electrode and the drain electrode, occupying an important part that determines the electrical characteristics of the device. The semiconductor layer formed in this step can respond sensitively to voltage changes, allowing for the control of current flow, which can influence the operational efficiency of the transistor. Proper material selection and manufacturing processes can help enhance the electrical performance of the device. In one embodiment, the semiconductor layer may comprise PEDOT:PSS and MXene. In one embodiment, the PEDOT:PSS and MXene included in the semiconductor layer may have a weight ratio of approximately 2:1 to 4:1. In one embodiment, the PEDOT:PSS and MXene included in the semiconductor layer may have a weight ratio of approximately 3:1.

The method for forming the source electrode and the drain electrode is not particularly limited. In one embodiment, the method for forming the source electrode and the drain electrode on the substrate is as follows: a metal electrode is patterned on the substrate using photolithography. First, a photoresist is coated on the substrate, and then the positions of the source electrode and the drain electrode are defined through UV exposure, followed by the formation of a pattern through a developing process. Thereafter, a conductive metal such as gold (Au) or silver (Ag) is deposited through a metal deposition process, and then unnecessary metal is removed through a lift-off process to form the desired electrode pattern.

The method for forming the semiconductor layer is not particularly limited. In one embodiment, the method for forming the semiconductor layer is as follows: after preparing a mixture of MXene and PEDOT:PSS, a thin semiconductor layer is formed on the substrate using spin coating. In this process, the weight ratio of MXene to PEDOT:PSS is adjusted to approximately 1:3 to provide optimal electrical properties. After spin coating, a heat treatment process is performed to stably form the semiconductor layer, during which excellent conductivity and a high on-off ratio can be achieved through the interaction between MXene and PEDOT:PSS.

The role of the BCP forming step is to form a lamella structure of the block copolymer, thereby imparting functions such as temperature-sensitive color change to the device. The BCP formed in this step can induce color changes in response to external stimuli or influence electrical properties. In particular, the regular nanostructure of the BCP may enhance the visual feedback function of the device and has the potential to provide flexible responsiveness in various application environments. In one embodiment, the block copolymer layer may comprise poly(styrene-block-2-vinyl pyridine) (PS-b-P2VP).

The method for forming the block copolymer layer is not particularly limited. In one embodiment, the method for forming the block copolymer layer is as follows: a thin layer is formed on the substrate by spin coating using poly(styrene-block-2-vinyl pyridine) (PS-b-P2VP) block copolymer. Thereafter, a lamella structure is formed through self-assembly between the PS and P2VP domains via a solvent vapor annealing process. The P2VP domain is converted to a cation with four covalent bonds using a mixed solution of bromoethane (BE) and dibromobutane (DBB), thereby imparting ion transport properties that can interact with the ion gel layer. The block copolymer layer thus formed induces structural color changes in response to temperature variations and can contribute to the temperature-sensitive characteristics of the device.

The role of the ion gel forming step is to enhance ionic mobility and electrical reactivity by adding a conductive ion gel layer to the device. The ion gel layer changes its physical properties according to temperature variations and plays an important role in regulating current flow. Additionally, the ion gel can interact with the block copolymer (BCP) to provide functionality that allows for more precise adjustments of the structural color changes or electrical properties of the device. This can help the device respond flexibly to temperature changes. In one embodiment, the ion gel layer may comprise poly(N-isopropylacrylamide) (PNIPAM) and lithium bis(trifluoromethanesulfonyl)imide (Li⁺TFSI⁻).

The method for forming the ion gel layer is not particularly limited. In one embodiment, the method for forming the ion gel layer is as follows: a mixture of poly(N-isopropylacrylamide) (PNIPAM) and lithium bis(trifluoromethanesulfonimide) (Li⁺TFSI⁻) is prepared to create an ion gel solution, which is then spin-coated onto the block copolymer layer. During the spin-coating process, the mixture of PNIPAM and Li⁺TFSI⁻ is coated to a uniform thickness, forming the ion gel layer. Subsequently, through a heat treatment process, the solvent evaporates, fixing the ion gel. The ion gel layer exhibits changes in physical properties depending on the temperature, which can provide temperature-responsive conductivity and visual feedback functions. In this process, the ion gel plays an important role in the electrical properties and temperature-responsive characteristics of the device.

The role of the converter connection step is to convert current into voltage within the device and amplify it for delivery to the actuator part. This step plays a crucial role in enabling the device to convert electrical signals into physical movements. By converting the current to an appropriate voltage, the operation of the actuator can be controlled, thereby enhancing the operational efficiency of the device. This conversion process can contribute to the device's ability to operate reliably in various environments.

In one embodiment, the bilayer structure of the actuator part may be prepared to comprise a first layer including PDMS and a second layer including PEDOT:PSS. In one embodiment, the bilayer structure of the actuator part may form the second layer only on a portion of the first layer. In one embodiment, the bilayer structure of the actuator part may be formed by stacking the first layer and the second layer, and then removing a portion to partially block the conductive path formed in the second layer, thereby extending the length of the conductive path.

The role of the gate electrode forming step is to form a gate electrode that adjusts and controls the electrical behavior of the device, thereby regulating the flow of current. The gate electrode controls the conductive path through the voltage applied to the semiconductor layer, which can determine the on-off state of the transistor. The gate electrode formed in this step may provide the possibility of optimizing the performance of the device and enabling more precise control of electrical signals.

The following describes embodiments of the present invention. However, the embodiments described below are merely some forms of the present invention, and the scope of the present invention is not limited to the embodiments provided below.

MXene/PEDOT:PSS-based temperature-responsive ion synapse with BCP structural color

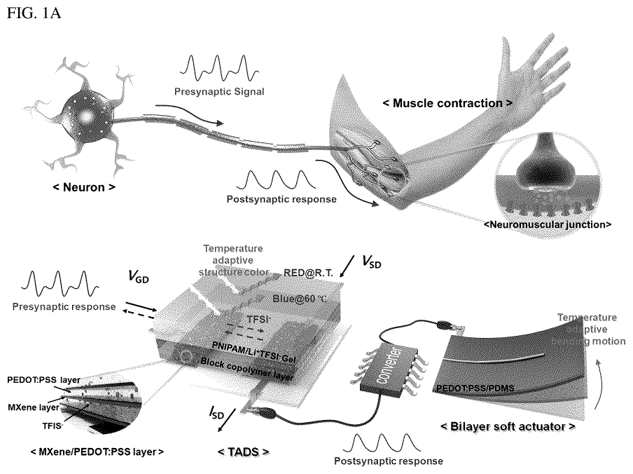

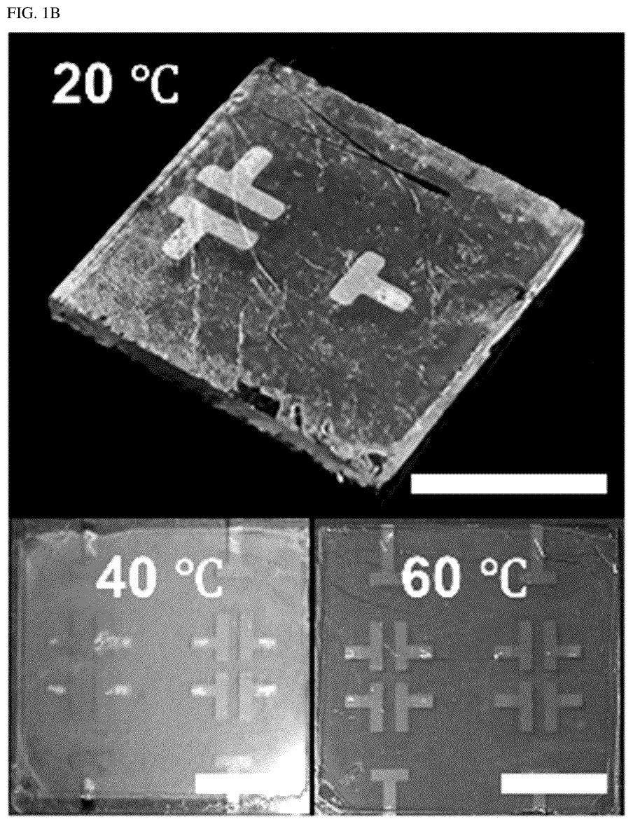

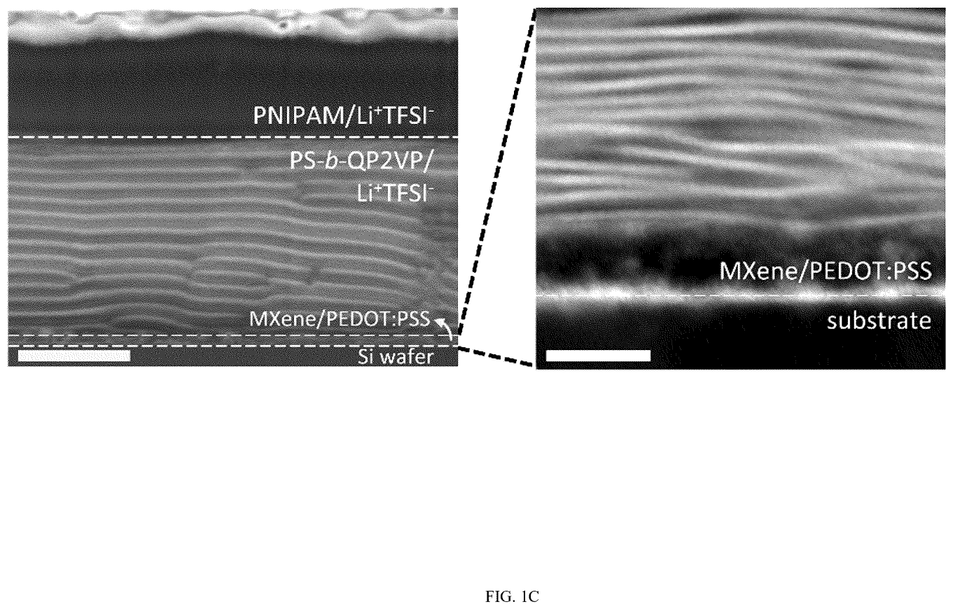

The temperature-adaptive neural-driven photonic skin of the present invention has been developed by integrating an ion gel synapse transistor that induces color change and a soft actuator. This enables synaptic signal transmission, color change, and actuation in response to temperature, providing various application possibilities suitable for human-machine interface technology (see FIG. 1A). This system mimics an artificial sensory-motor nervous system within the body that processes neural signals and motor responses. The TADS (Temperature Adaptive Neural Driven Device) of the present invention transmits signals from thermal sensory receptors to muscle cells and conveys neural signals between the transfer neurons and post-synaptic neurons through a neural network connected by biological synapses (see the upper part of FIG. 1A). At the axon terminals of the post-synaptic neurons, the neuromuscular junction transmits thermal stimuli to muscle cells, enabling an effective human thermal stimulus response.

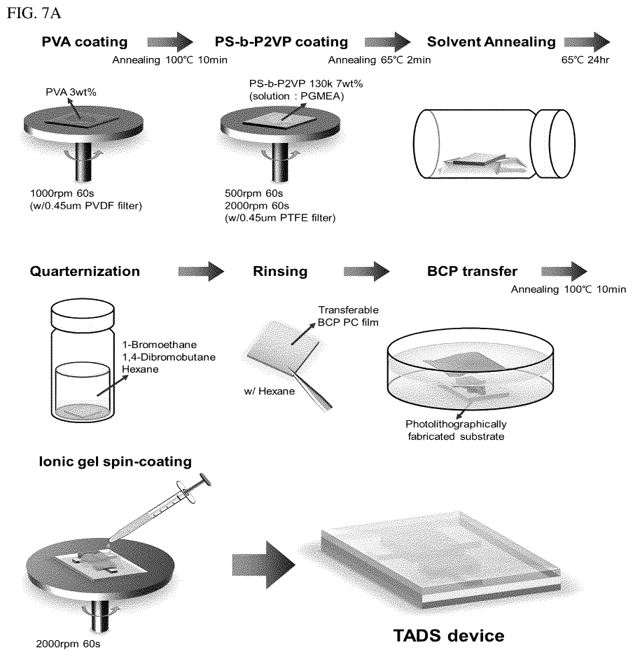

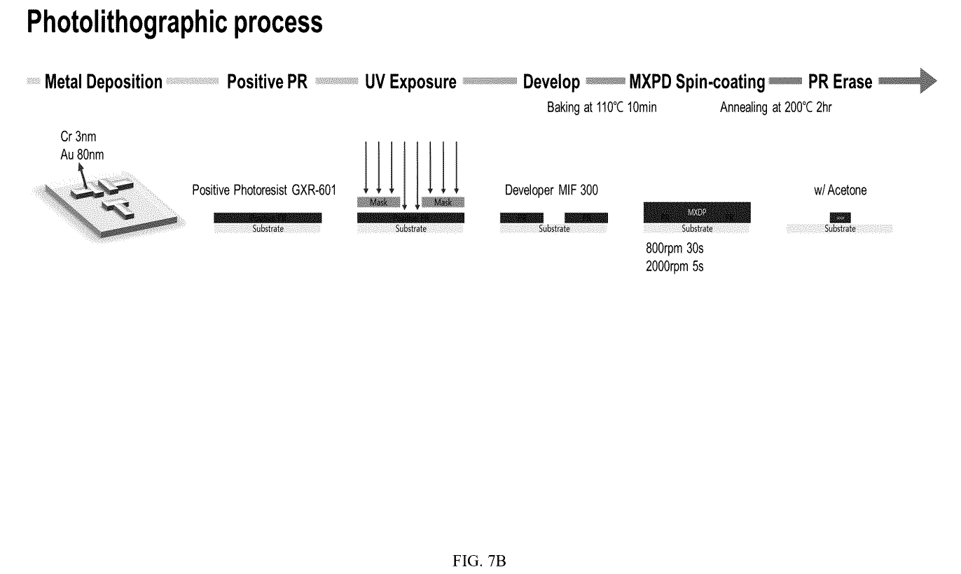

TADS is an electrochemical transistor (ECT) that has a three-terminal electrode consisting of a source(S), drain (D), and side gate (G). A channel measuring 3 mm×4 mm, composed of MXene and PEDOT:PSS, was coated onto the source and drain electrodes and fabricated using photolithography with positive photoresist (for detailed information, refer to the experimental section). In addition to the MXene/PEDOT:PSS channel layer, a one-dimensional block copolymer (BCP) photonic crystal (PC) film composed of self-assembled lamellae and ion gel was sequentially stacked. The BCP PC was used to induce structural color changes in the visible range in response to temperature. Poly(styrene-block-2-vinyl pyridine) (PS-b-P2VP) (average molecular weight: 130 kg mol⁻¹) was synthesized to have alternating PS and P2VP domains arranged periodically in the plane through solvent vapor annealing. The amine groups in the pyridine rings of the P2VP domains were converted into cations with four covalent bonds using a mixed solution of 1,4-dibromobutane (DBB) and 1-bromoethane (BE), allowing easy access to the ionic liquid within the ion gel and enabling the formation of ionic bonds between DBB molecules and QP2VP chains. The temperature-responsive ion gel was developed by mixing a solution of poly(N-isopropylacrylamide) (PNIPAM) and lithium bis(trifluoromethanesulfonyl)imide (Li⁺TFSI⁻) in acetonitrile and was coated on top of PS-b-QP2VP through spin coating. All manufacturing processes are described in FIG. 7.

TADS exhibits temperature-sensitive structural color changes in the BCP PC film and demonstrates temperature-responsive synaptic behavior in the MXene/PEDOT:PSS channel layer (refer to the lower part of FIG. 1A). At approximately 48° C., PNIPAM undergoes a sol-gel transition, which alters the compatibility of Li⁺TFSI⁻ within PNIPAM. Above the sol-gel transition temperature, the ion gel transforms into a sol state, attracting Li⁺TFSI⁻ molecules from QP2VP within the BCP film, causing the QP2VP domains to contract and shifting the structural color of the BCP to blue. Conversely, when the PNIPAM film cools to room temperature, the ion gel changes into a translucent gel due to phase separation between PNIPAM and Li⁺TFSI⁻ molecules. In this case, excessive Li⁺TFSI⁻ molecules, which do not participate in phase separation, easily diffuse into the QP2VP domains, expanding the QP2VP layer within the BCP PC film and shifting the structural color of the BCP to red. Additionally, the conductivity of the MXene/PEDOT:PSS channel in the ion gel transistor varies according to the sol-gel transition temperature of the ion gel, as the number of Li⁺TFSI⁻ molecules associated with the channel is influenced by the sol-gel transition. For example, the drain-source current (IDS) is proportional to the number of TFSI-ions moving through this multilayer channel, and as the temperature decreases, IDS increases due to the additional flow of Li⁺TFSI⁻ molecules entering the channel. The temperature-responsive synaptic performance was evaluated by monitoring the temperature-adaptive IDS in response to various electric gate stimuli, and it was confirmed that the structural color change of the BCP also varies with temperature. Next, TADS was connected to a bilayer type soft actuator composed of a PDMS layer coated with PEDOT:PSS (refer to FIG. 1A). The temperature-responsive IDS (corresponding to the post-synaptic current (PSC)) is converted into a voltage signal capable of driving the actuator connected to TADS. This demonstrates that the artificial somatosensory sensor has the capability to recognize temperature and provide feedback to control artificial muscles.

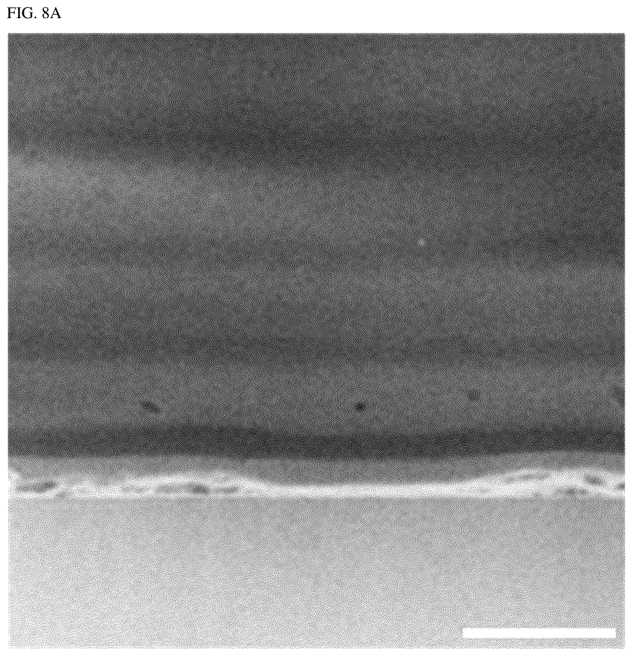

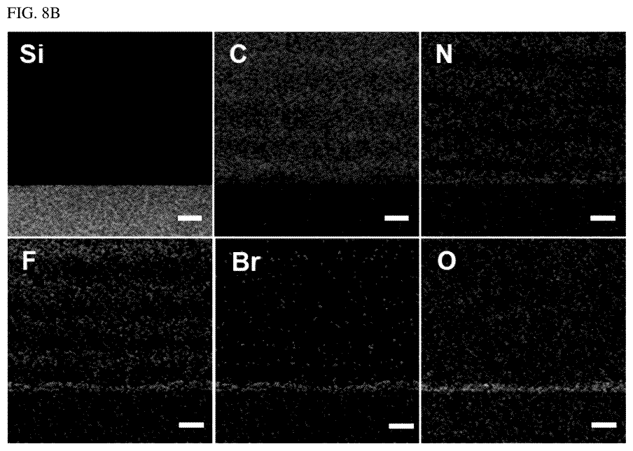

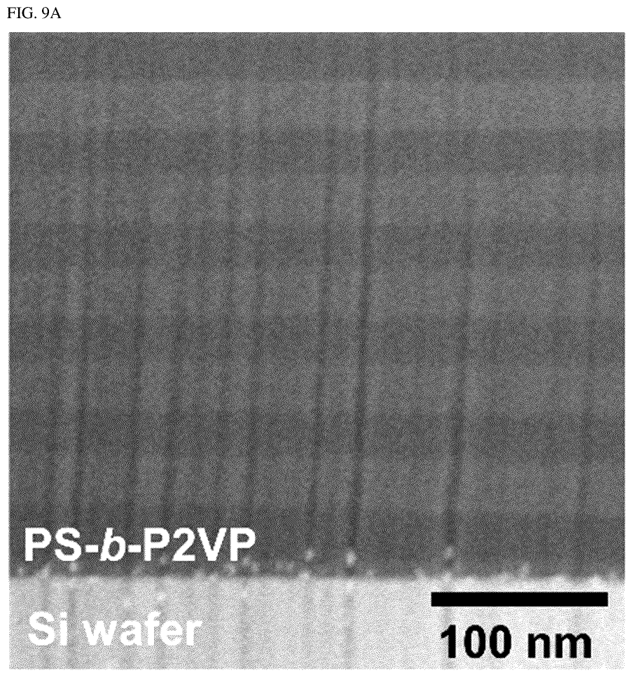

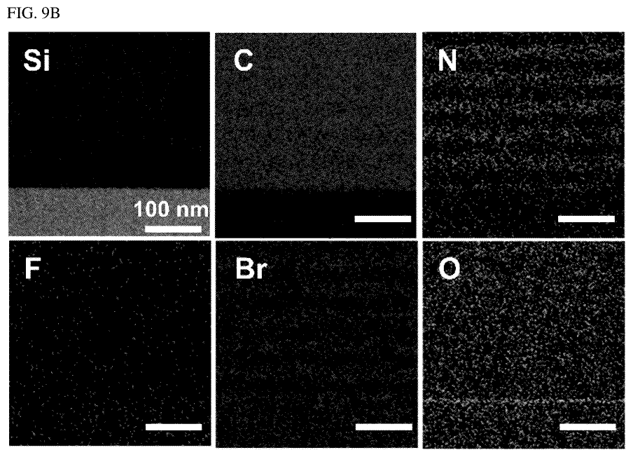

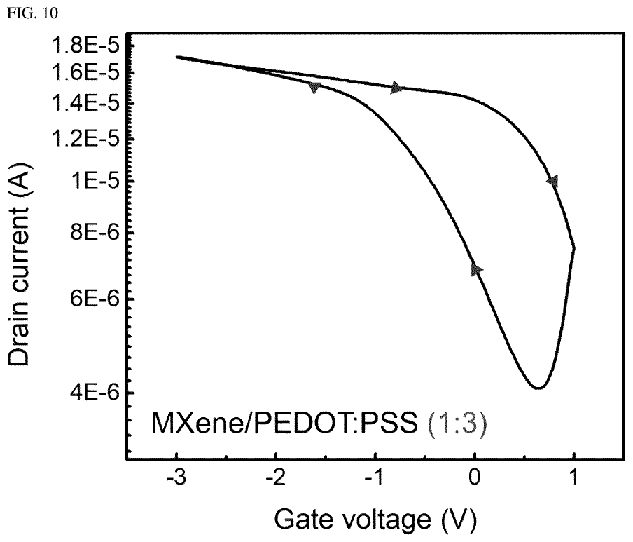

TADS exhibited structural colors of red, green, and blue at 20° C., 40° C., and 60° C., respectively, as shown in FIG. 1B. According to the SEM image showing the cross-section of TADS (left view in FIG. 1C), the thicknesses of the MXene/PEDOT:PSS channel layer, the BCP layer expanded with Li⁺TFSI⁻, and the ion gel layer were approximately 100 nm, 1.75 μm, and 1.55 μm, respectively. The channel layer with a thickness of 100 nm was confirmed through transmission electron microscopy (TEM), as indicated in the right view of FIG. 1C. Additionally, bromine (Br) was observed in the QP2VP domain through energy dispersive spectroscopy (EDS) analysis, indicating that the P2VP domain was converted into cations with four covalent bonds with BE and DBB. It can also be noted that the QP2VP layer expanded due to interactions with LiTFSI ions (refer to FIG. 8 and FIG. 9). The first layer on the Si substrate consists of a polar QP2VP lamella containing a small amount of LiTFSI. The domain was not fully expanded by LiTFSI due to insufficient diffusion of LiTFSI at the top of the BCP film.

### Analysis of the MXene/PEDOT:PSS Channel

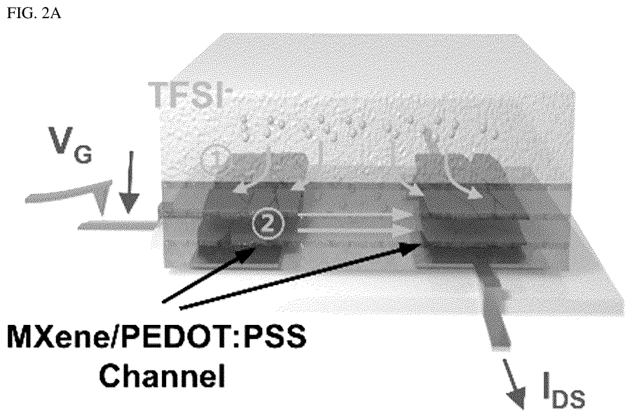

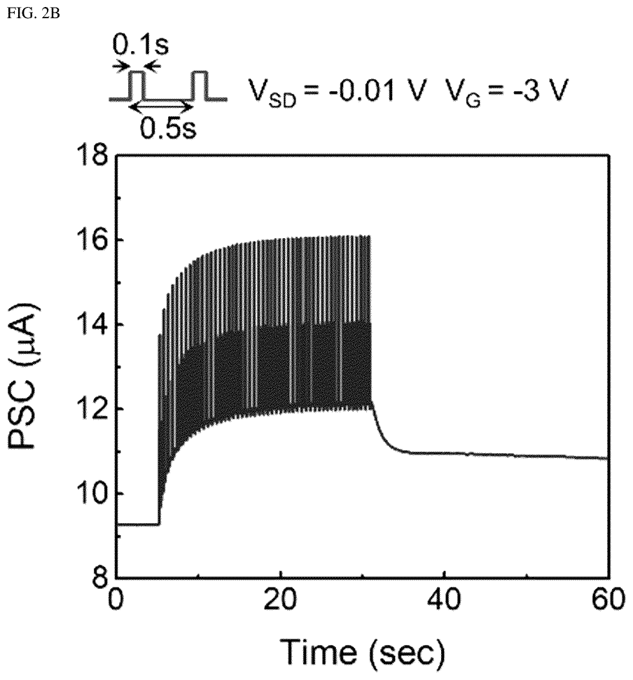

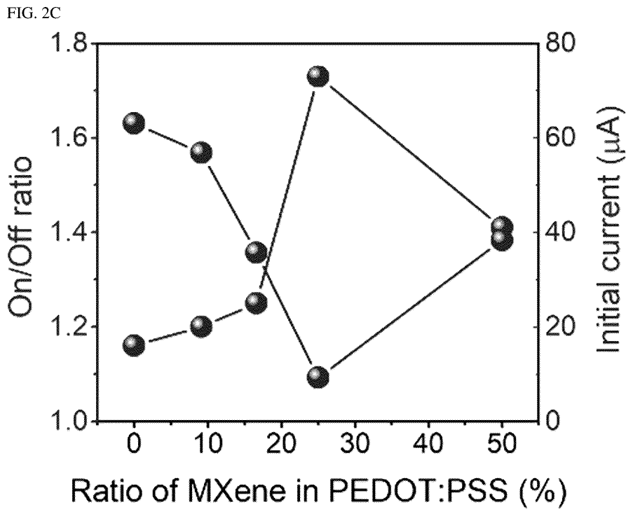

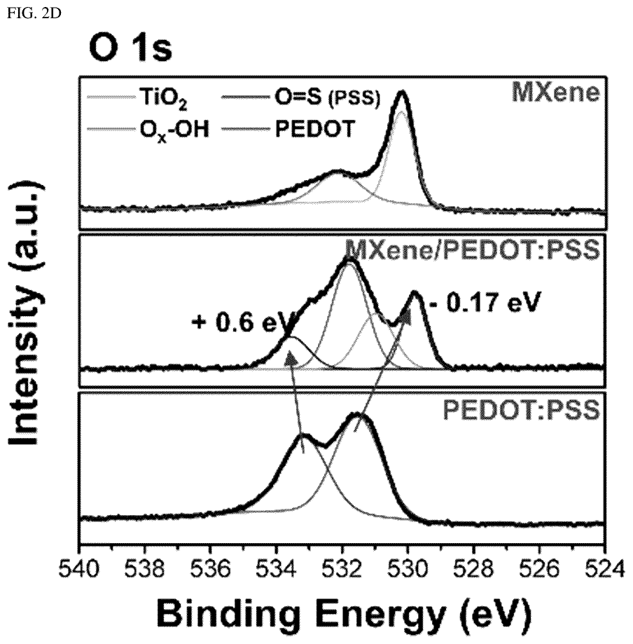

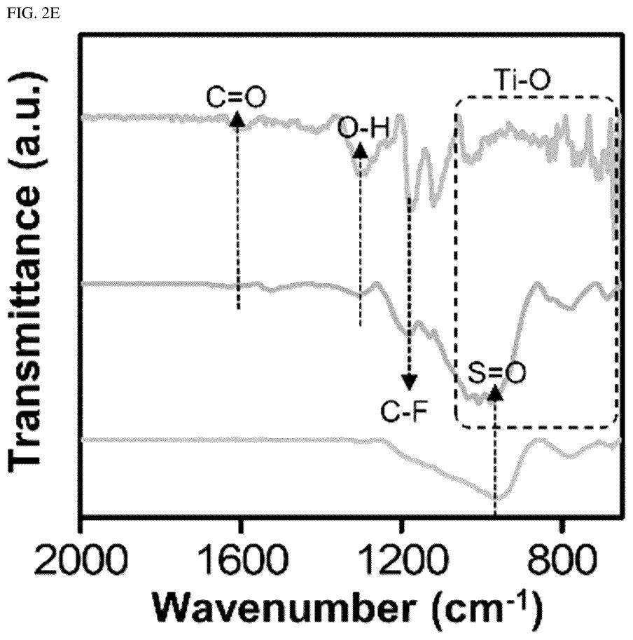

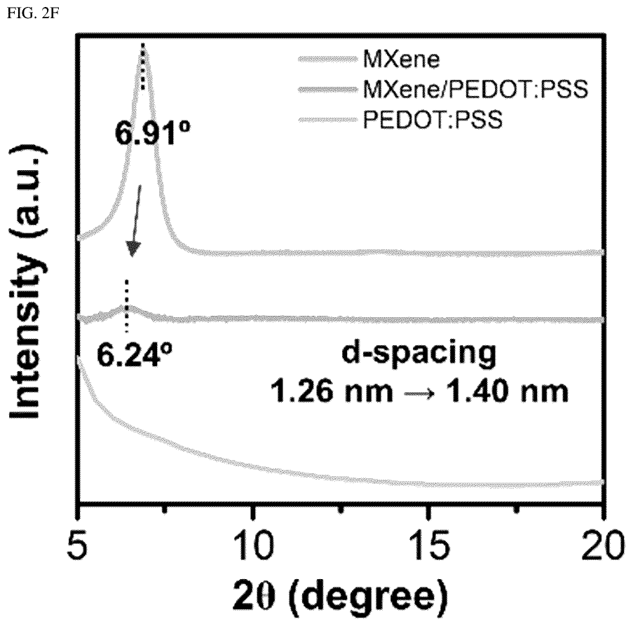

The electrical and chemical properties of the MXene/PEDOT:PSS channel were investigated (FIG. 2). FIG. 2A schematically shows the process of neurotransmission signals being transmitted between the pre-neuron and the post-neuron through TADS. In this system, the excess TFSI anions in the ion gel diffuse into the MXene/PEDOT:PSS when a negative gate bias is applied through the lithium-affinity QP2VP layer of the BCP. Subsequently, the holes injected from the source electrode of the transistor combine with the anions, resulting in the formation of polarons within the semiconductor channel, which enhances the channel conductivity. During LTD (long-term depression), the channel conductivity decreases as TFSI anions are de-doped from the channel when continuous positive gate pulses are applied. By applying 2D MXene nanosheets to the PEDOT:PSS channel of TADS, the ON/OFF synaptic current ratio was improved, as shown in FIG. 2B. In this system, the highest ON/OFF current ratio of approximately 1.73 was obtained in a semiconductor channel (MXene/PEDOT:PSS (1:3)) mixed with about 25 wt % MXene within a gate voltage range of 0 V to −3 V. Previous studies have demonstrated that the abundant hydroxyl groups on the MXene nanosheets preferentially interact with the PEDOT:PSS chains due to hydrogen bonding, facilitating the intercalation of PEDOT:PSS between the MXene nanosheets. Additionally, it was confirmed that the ion gel transistor with MXene/PEDOT:PSS exhibited p-type characteristics due to the p-type PEDOT:PSS semiconductor, contrasting with the n-type characteristics of the MXene semiconductor channel. This is related to the preferential interaction between MXene and Li ions.

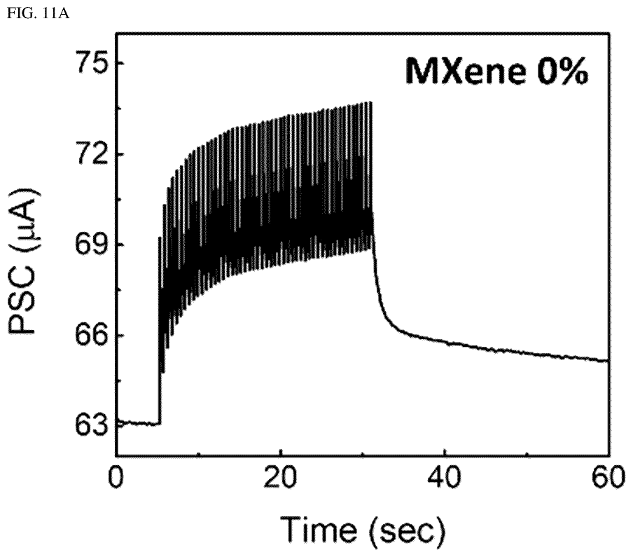

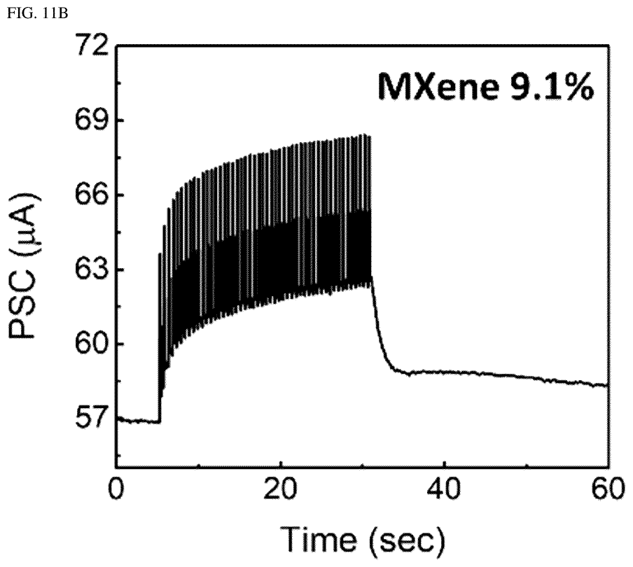

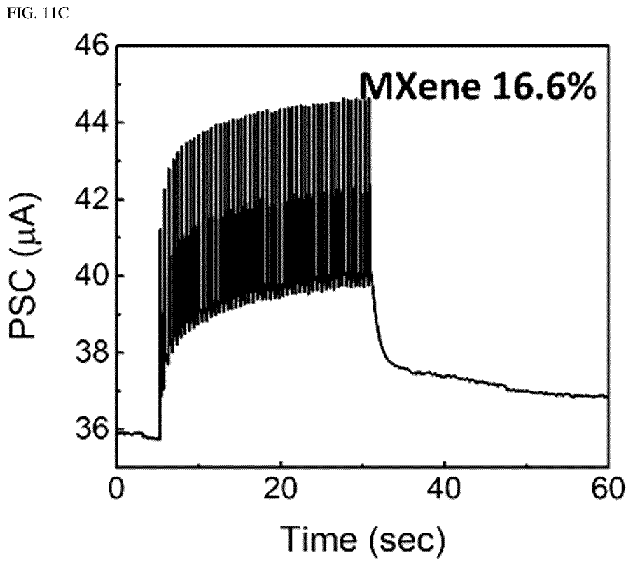

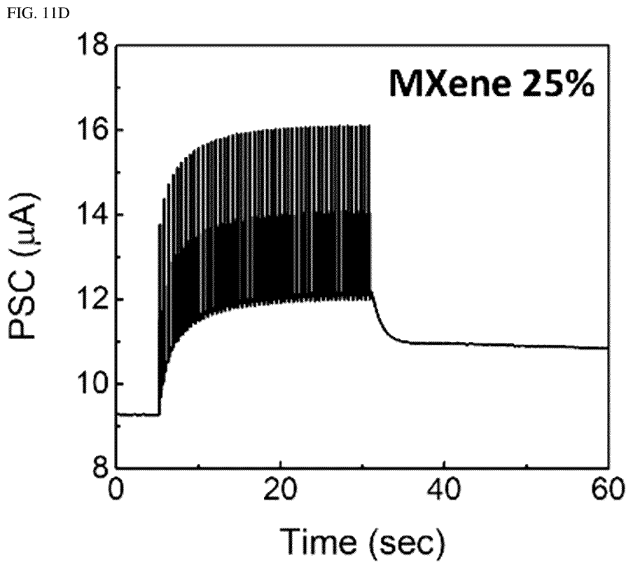

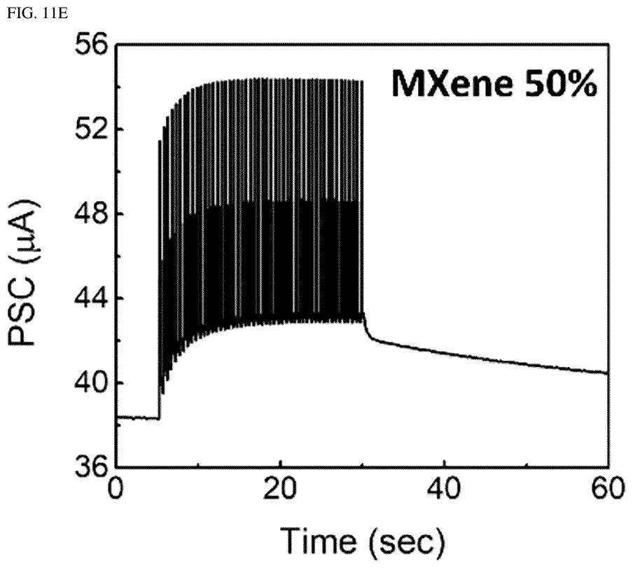

FIG. 2B shows the PSC (synaptic current) behavior of TADS using an MXene/PEDOT:PSS (1:3) channel under continuous gate pulses of −3 V. The device exhibited rapid saturation of LTP (long-term potentiation) during gate pulses with a pulse duration of 0.1 seconds and an interval of 0.5 seconds, which was facilitated by the high anion selectivity of PEDOT:PSS as TFSI ions were doped into the channel. After the synaptic pre-pulse ended, the PSC gradually decreased over time, effectively mimicking the analog weight update function of biological synapses. The initial current of the TADS using the MXene/PEDOT:PSS channel was significantly reduced due to the decrease in hole carriers at zero gate bias caused by the negatively charged MXene in the channel. The initial channel current values and the ON (maximum LTP current)/OFF (initial current) ratio of the TADS using the MXene/PEDOT:PSS channel are summarized in FIG. 2C and FIG. 11. Although the initial current value was significantly reduced due to the MXene, the ON/OFF ratio in the synaptic characteristics improved by adding MXene. For example, the initial ID before applying VG in the TADS without MXene decreased from 63.07 μA to 9.27 μA in the TADS using MXene/PEDOT:PSS (1:3), resulting in an improvement of the ON/OFF ratio from 1.16 to 1.73. However, in the MXene/PEDOT:PSS (1:1) channel, the initial ID increased due to the highly conductive MXene, leading to a decrease in the ON/OFF ratio to 1.41. The improvement in the ON/OFF ratio is advantageous for the development of temperature-sensitive synaptic transistors, which will be discussed later. Based on these results, TADS with an MXene/PEDOT:PSS (1:3) semiconductor channel was selected for further research on temperature-sensitive synaptic characteristics.

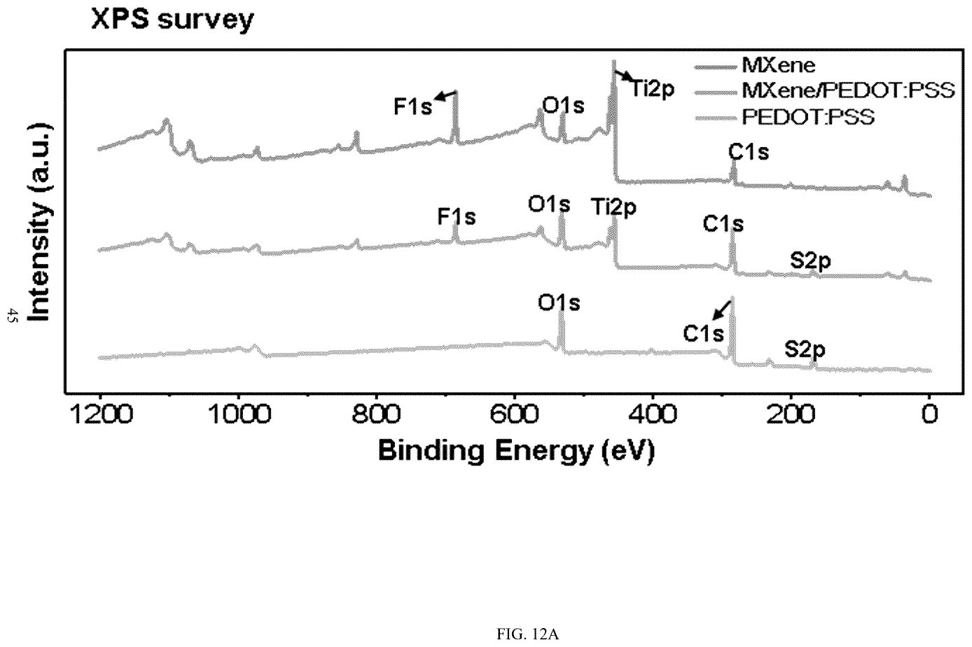

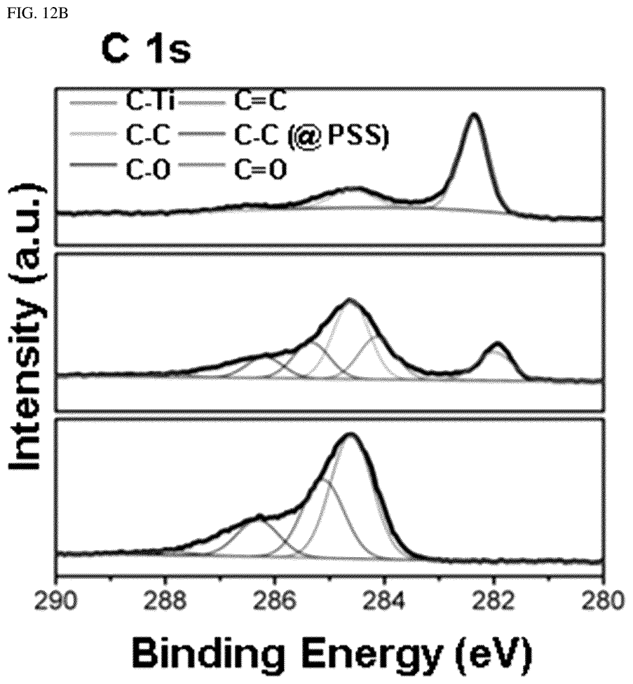

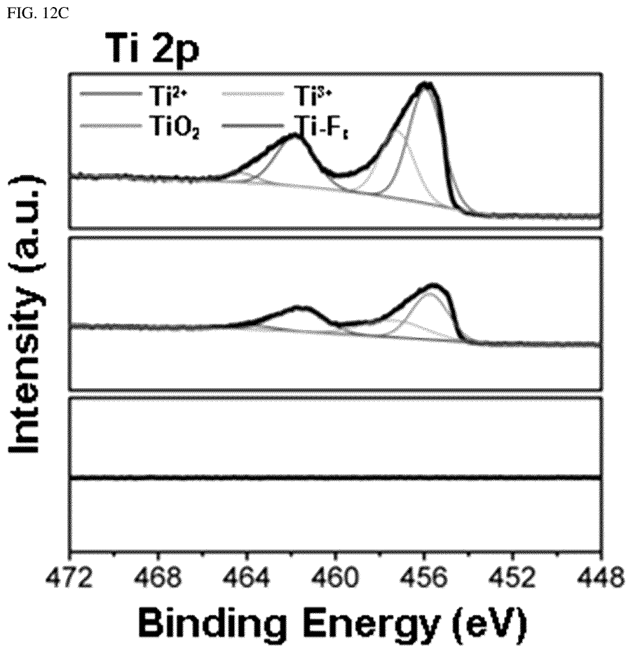

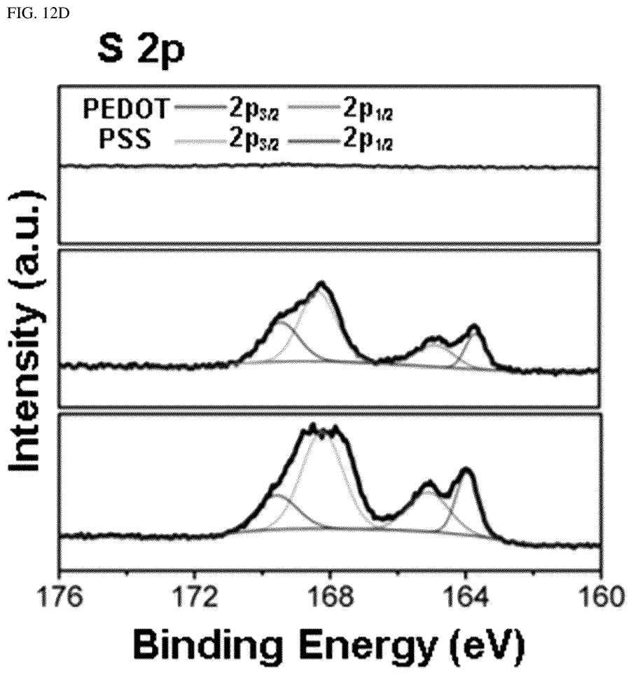

To elucidate the molecular interactions between MXene and PEDOT:PSS, X-ray photoelectron spectroscopy (XPS) was performed, and the results were analyzed using Gaussian-Lorentzian fitting. The elements corresponding to MXene, Ti, C, O, and F, as well as the elements C and S corresponding to PEDOT:PSS, were analyzed using XPS. The O 1s spectrum in FIG. 2D shows peaks at 529.90 eV and 531.79 eV, which are attributed to the Ox-OH bonds derived from TiO2 and MXene, respectively. The peaks at 531.15 eV and 532.95 eV correspond to the O═S bond of PSS and the O atoms of PEDOT in pure PEDOT:PSS. Compared to the pure PEDOT:PSS film, the peak of PEDOT in the MXene/PEDOT:PSS film shifted to a binding energy approximately 0.6 eV higher, while the peak of PSS shifted approximately 0.17 eV lower. The observed energy shifts in the two peaks can be attributed to hydrogen bonding and π-π interactions between MXene and PEDOT:PSS. The S 2p spectrum demonstrates the molecular interactions between MXene and PEDOT:PSS. The relatively low-intensity peaks at 163.98 eV (S 2p 3/2) and 165.08 eV (S 2p½) correspond to the S atoms within PEDOT, while the high-intensity peaks at 168.29 eV (S 2p 3/2) and 169.59 eV (S 2p½) correspond to the S atoms in the sulfonic acid groups of PSS. The intensity ratio of the peaks related to PEDOT and PSS was 1:2.40 in the pure PEDOT:PSS film, but changed to 1:1.81 in the MXene/PEDOT:PSS film. This result suggests that π-π interactions between MXene and PEDOT are formed, disrupting the electrical interactions and causing phase separation between PEDOT and PSS. The C 1s, Ti 2p, and F 1s spectra are shown in FIG. 12.

The functional groups of the MXene/PEDOT:PSS film were analyzed using Fourier Transform Infrared Spectroscopy (FT-IR) and compared with those of MXene and PEDOT:PSS. As shown in FIG. 2E, the peak at 1597 cm⁻¹ corresponds to the stretching vibration of the C═O bond. The characteristic peak near 1320 cm⁻¹ is associated with the O—H stretching bond. The peak corresponding to the C—F stretching bond is located at 1196 cm⁻¹, and the S═O stretching bond was observed at 1012 cm⁻¹. The broad band below 1100 cm⁻¹ corresponds to the Ti—O stretching and Ti—O—Ti bending vibration modes. The interlayer spacing of the layer combined with MXene and PEDOT:PSS was analyzed using High-Resolution X-ray Diffraction (HR-XRD). As shown in FIG. 2F, the (100) diffraction peak of pure MXene film is located at 6.91°, while it shifted to 6.24°in the MXene/PEDOT:PSS film. The interlayer spacing (d) of MXene and MXene/PEDOT:PSS films, calculated according to Bragg's equation, was approximately 1.26 nm and 1.40 nm, respectively, confirming that the interlayer spacing has expanded.

### Synaptic Characteristics of Ion Synapses at Room Temperature

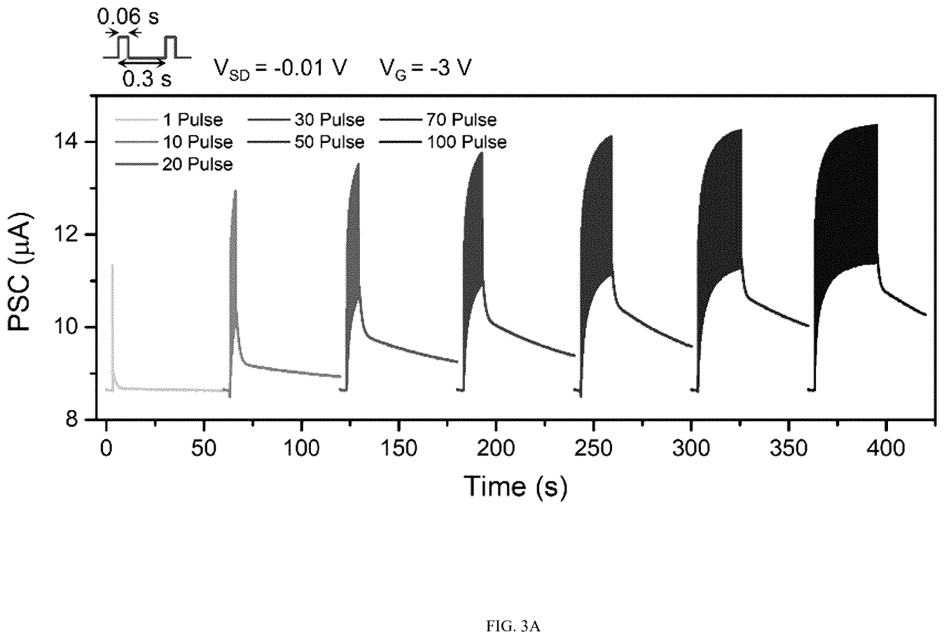

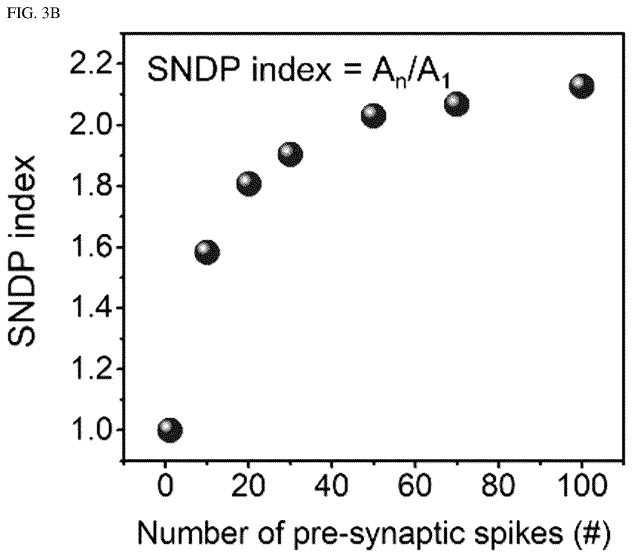

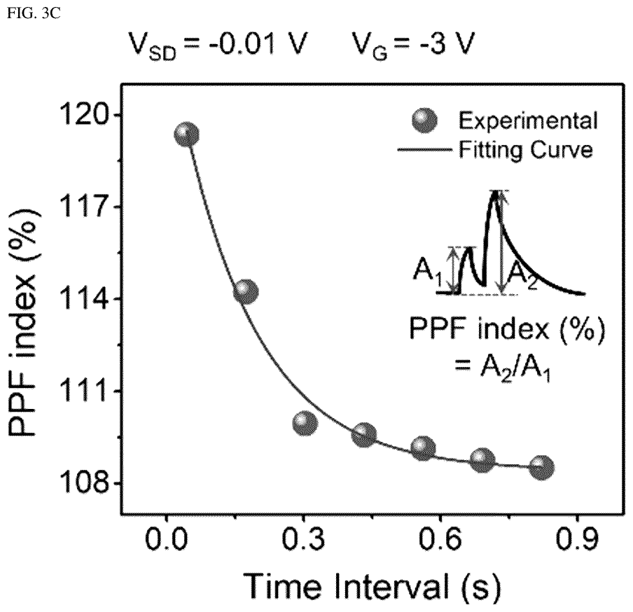

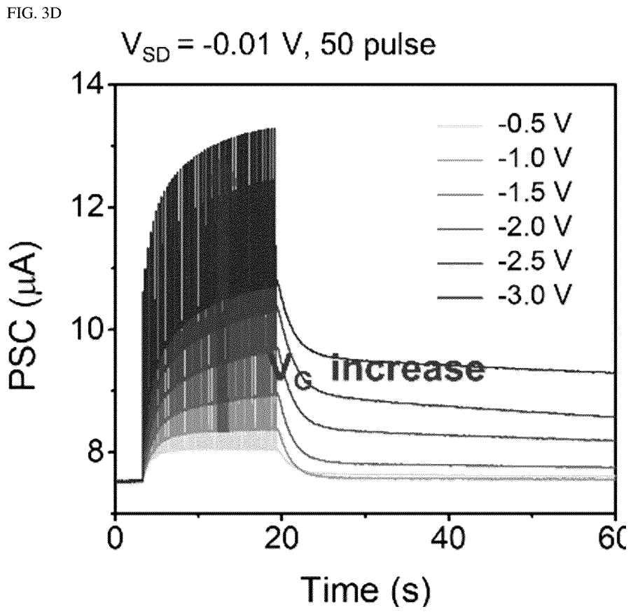

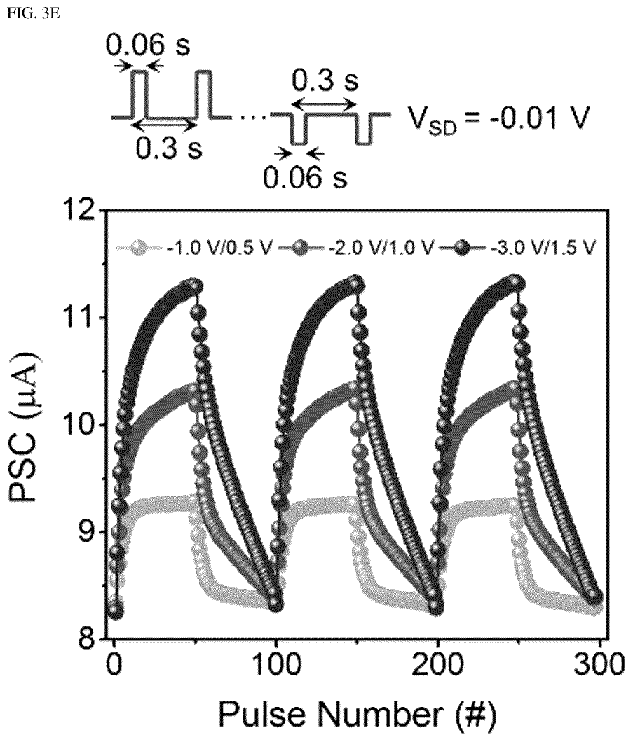

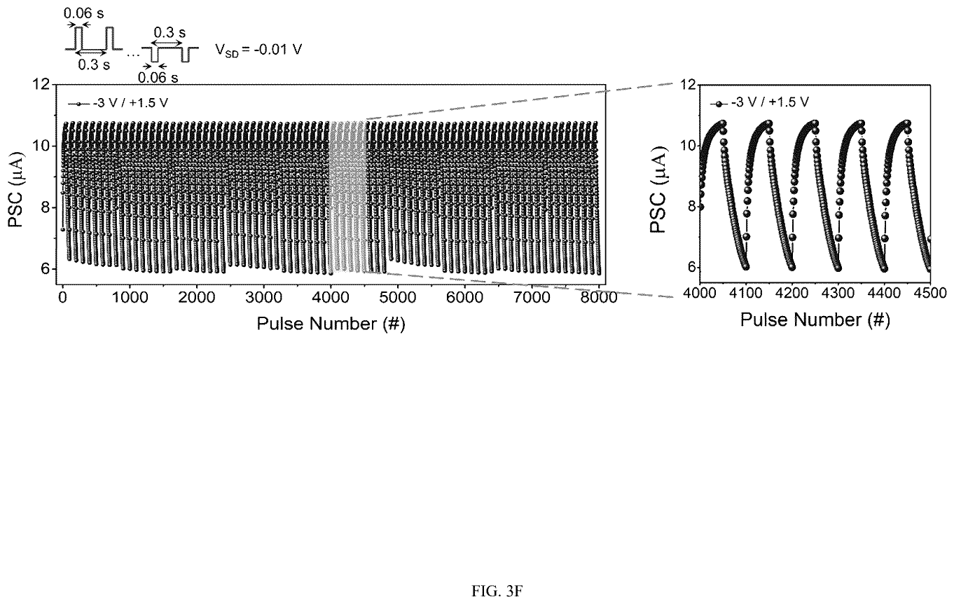

The synaptic characteristics of TADS, namely post-synaptic current (PSC), spike number-dependent plasticity (SNDP), paired-pulse facilitation (PPF), and long-term potentiation/depression (LTP/D), were studied at room temperature, and the results are shown in FIG. 3. To confirm how the synaptic strength of TADS changes according to the number of input spikes, the PSC of TADS was measured while increasing the number of gate pulses to 1, 10, 20, 30, 50, 70, and 100 (each pulse was −3 V, with a pulse duration of 0.06 seconds, a 0.3-second interval, and VSD of −0.01 V). According to the results shown in FIG. 3A, as the number of pulses increased, the PSC value also increased, indicating a clear dependence of synaptic strength on the number of input spikes. Specifically, the maximum PSC value, which was approximately 11.3 μA for 1 pulse, increased to about 14.4 μA for 100 pulses. To quantify this relationship, the SNDP index was calculated by dividing the PSC value after n pulses by the PSC value after the first pulse, and this is presented in FIG. 3B. The SNDP index sharply rises as the number of spikes increases, and then shows a gradual increase after about 50 spikes. Additionally, FIG. 3C represents the paired-pulse facilitation (PPF) index, defined as the ratio of the first PSC peak (A1) to the second PSC peak (A2) (A2/A1). This PPF index decreases exponentially as the interval (Δt) between the first and second pulses increases. This electrical behavior demonstrates the potential to mimic the neural synaptic plasticity similar to that occurring in biological synapses, particularly in the human brain.

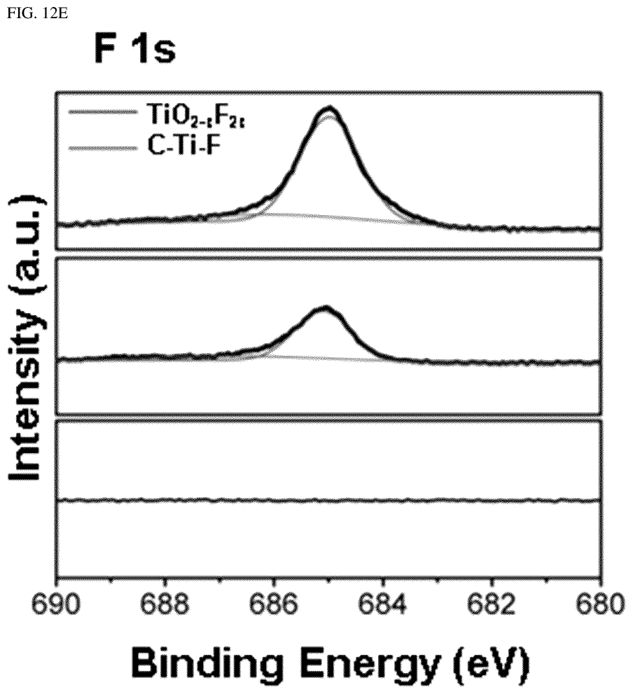

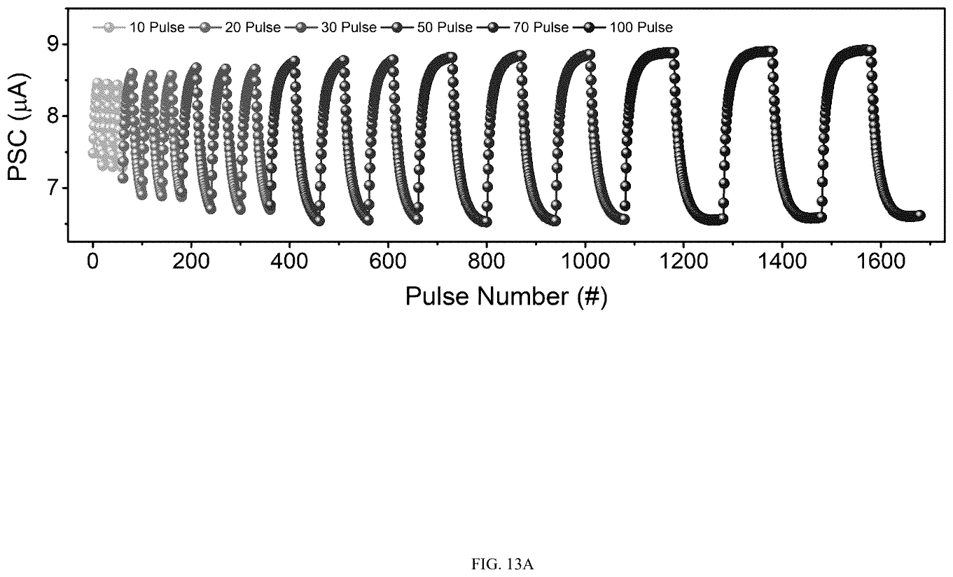

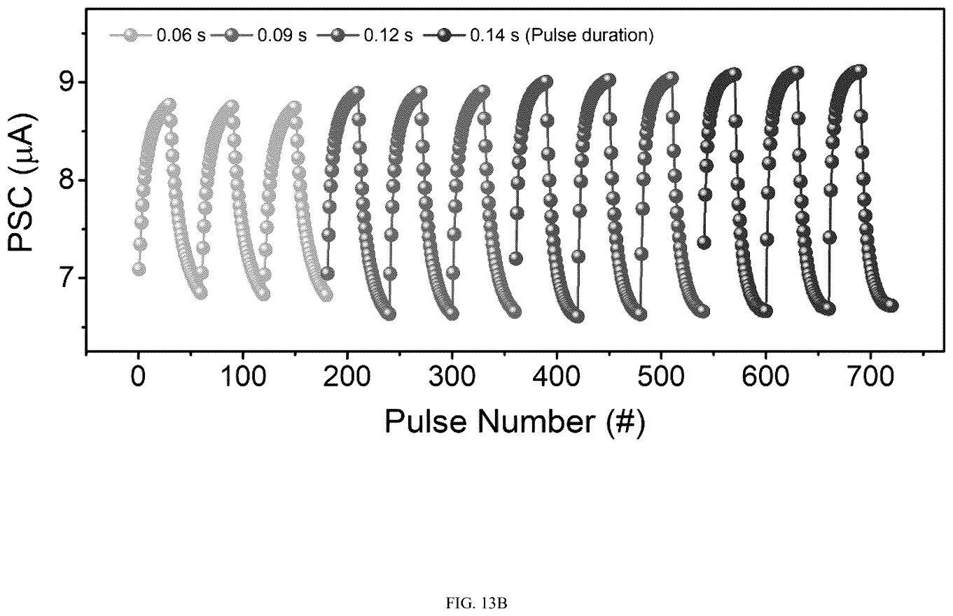

To further investigate the synaptic behavior of TADS, the amplitude of the gate pulse was varied (from −0.5 V to −3 V) to examine the synaptic response (FIG. 3D). The results indicate that when the gate voltage is −0.5 V, the PSC value starts at 8.47 μA and increases to 13.3 μA at a gate voltage of −3.0 V, suggesting that stronger stimulation leads to greater signal transmission. The LTP/LTD characteristics are among the most important features in neuromorphic systems, as the key parameters of the LTP/LTD curve significantly affect the accuracy of learning and recognition tasks. In FIG. 3E, sequential LTP and LTD were achieved by applying various gate voltage sequences. The TADS device demonstrated reliable LTP and LTD cycling at various gate voltages of −1 V/+0.5 V, −2 V/+1.0 V, and −3 V/+1.5 V, proving its strong synaptic modulation capability. This device exhibited the highest maximum PSC value at a gate voltage of −3 V, which decreased as the positive gate voltage increased to +1.5 V. Additionally, the ON/OFF ratio of the PSC increased at higher gate voltages, consistent with previous studies on ion gel-based synaptic transistors. To further investigate synaptic behavior, LTP and LTD experiments were conducted as a function of pulse number and pulse duration (FIG. 13). The results show that during LTP, the PSC increased proportionally with both the pulse number and pulse duration. Long-term reliability and durability were assessed through repetitive LTP/LTD cycling (each cycle consisting of 50 gate pulses at −3 V for LTP and 50 gate pulses at +1.5 V for LTD), with the results shown in the left panel of FIG. 3F. The TADS device maintained a stable PSC response throughout the testing period after 80 cycles of LTP/LTD. The right panel of FIG. 3F provides an expanded view of the PSC profile during pulses between 4000 and 4500, further confirming long-term stability.

### Temperature-Adaptive Synapse and Structural Color Characteristics of TADS

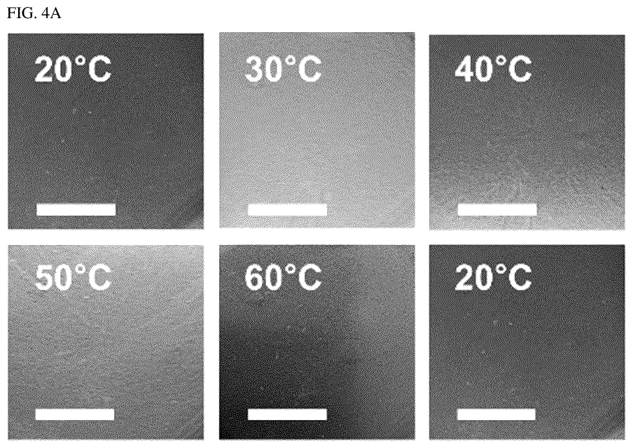

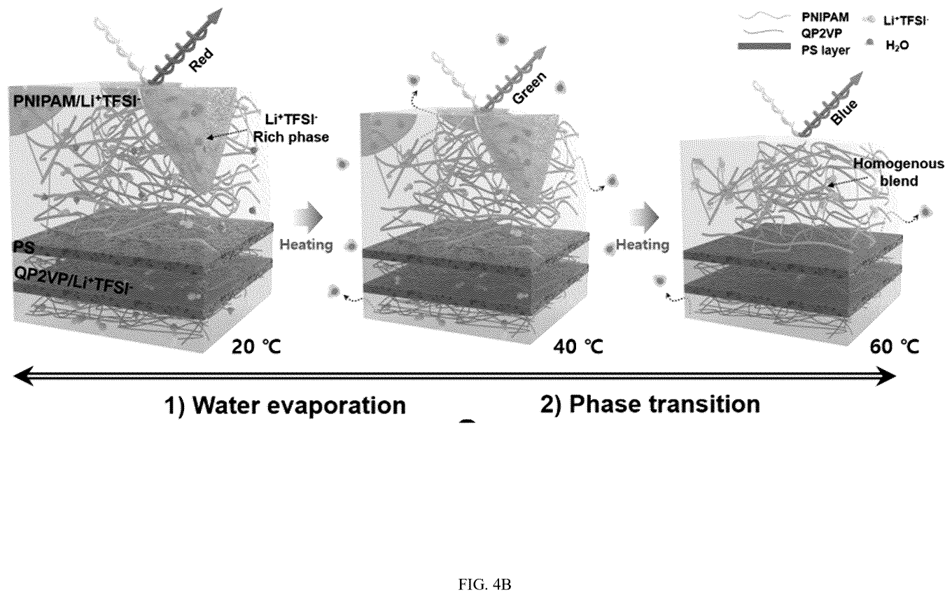

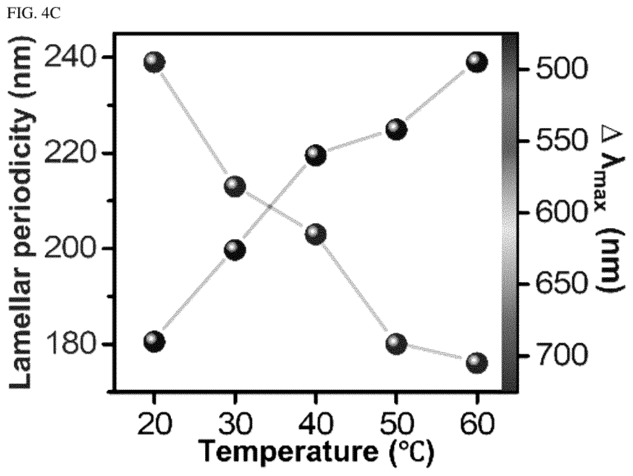

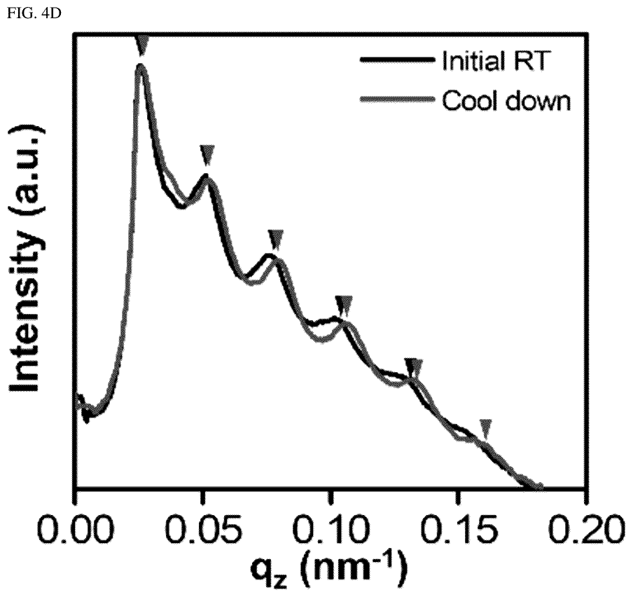

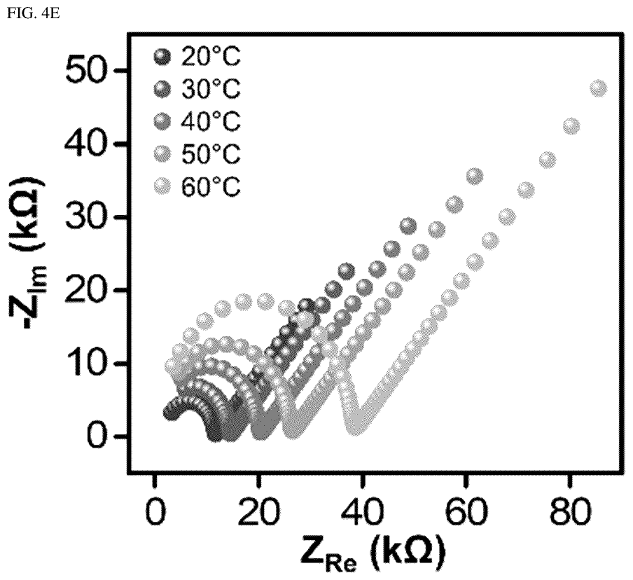

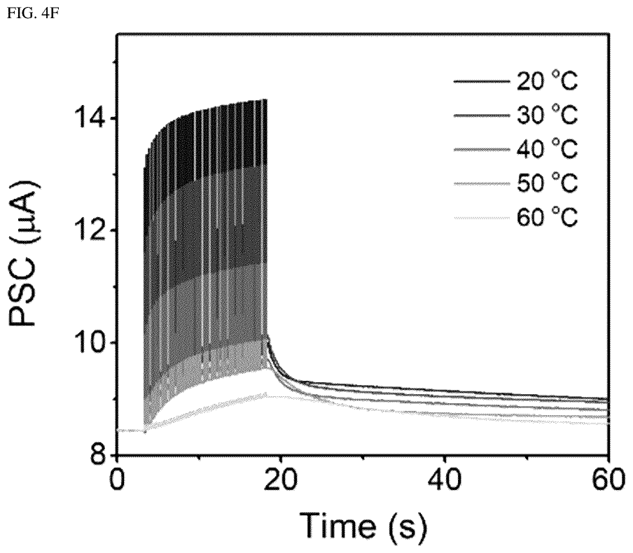

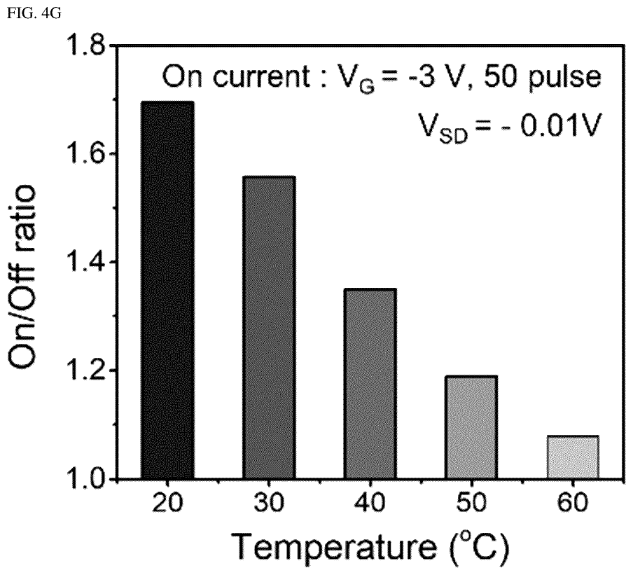

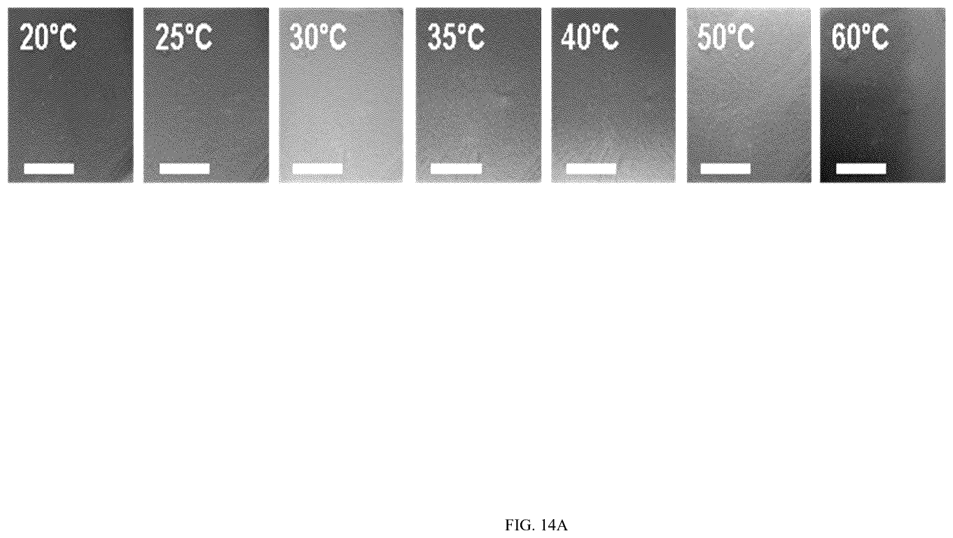

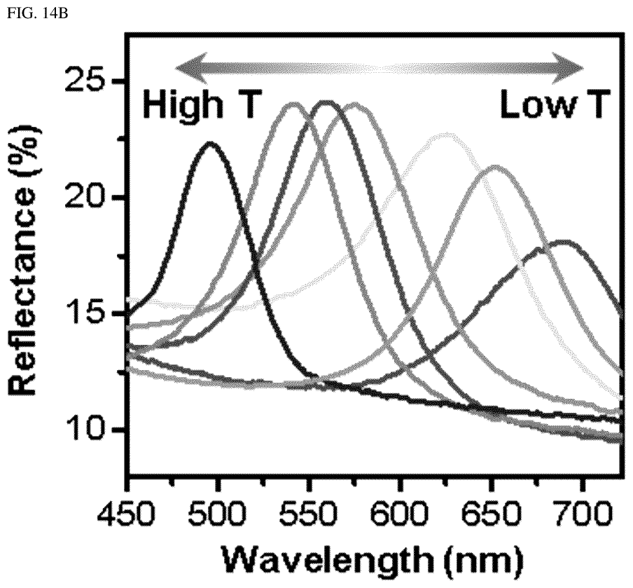

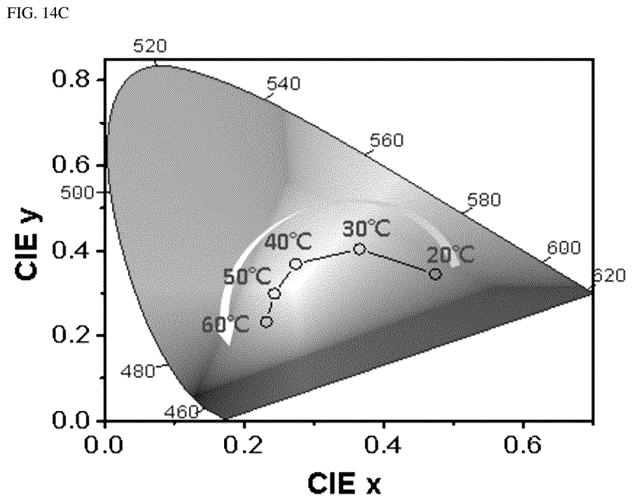

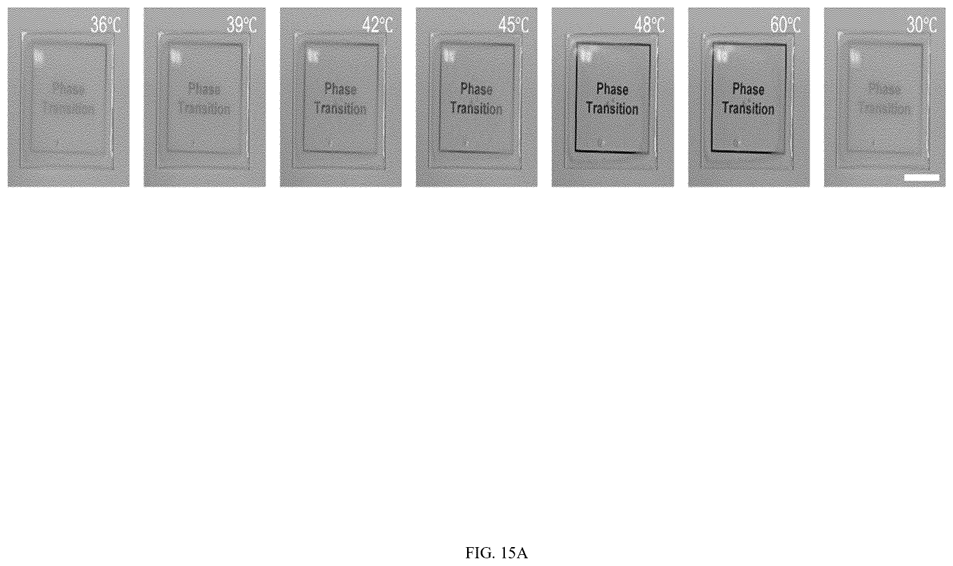

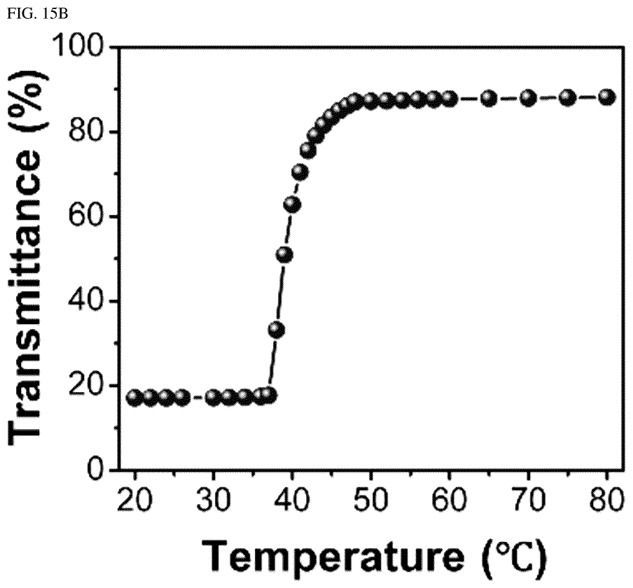

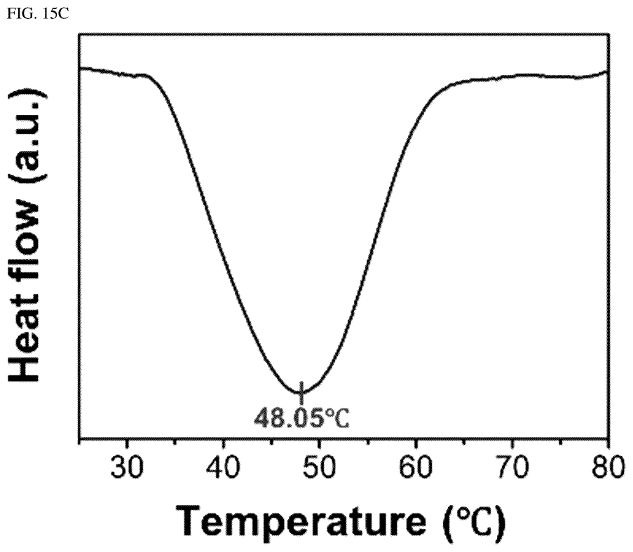

As shown in FIG. 1B, TADS exhibits temperature-adaptive structural colors across the entire visible spectrum due to the temperature-responsive ion gel stacked on the BCP photonic crystal. According to FIG. 4A (also see FIG. 14A), the device, which initially displayed a red structural color at 20° C., changed to orange, green, and blue at 30° C., 40° C., and 60° C., respectively. When the device was cooled to room temperature, the red structural color reappeared (FIG. 4A). This temperature-adaptive and reversible structural color change of TADS is attributed to the phenomenon where Li⁺TFSI⁻ selectively binds with moisture molecules, leading to the influx into the QP2VP domain depending on temperature. As illustrated in the schematic of FIG. 4B, the QP2VP lamella is swollen with hygroscopic Li⁺TFSI⁻ containing moisture molecules, initially displaying a red structural color. As the temperature rises, the moisture molecules bound to Li⁺TFSI⁻ evaporate, causing the QP2VP lamella to contract, resulting in a change of the device's structural color to green (the middle schematic of FIG. 4B). When the ion gel layer (PNIPAM and Li⁺TFSI⁻) reaches the sol-gel transition temperature, the ion gel layer becomes transparent, and the solubility of Li⁺TFSI⁻ in PNIPAM significantly increases. The translucent Li⁺TFSI⁻/PNIPAM gel at room temperature transforms into a clear transparent sol when exceeding the sol-gel transition temperature (approximately 48° C.), which was confirmed in a series of photographs (see FIG. 15A). Additionally, the UV-visible spectroscopic analysis measuring the optical transmittance of the Li⁺TFSI⁻/PNIPAM ion gel with respect to temperature revealed a sharp increase in transmittance at 48° C., which corresponds to the peak observed in differential scanning calorimetry (DSC), further demonstrating the sol-gel transition of this mixed film (see FIG. 15B and FIG. 15C). Furthermore, moisture molecules bound to Li⁺TFSI⁻ in the ion gel layer were confirmed by FTIR spectroscopy with a peak at 3386 cm−1 (see FIG. 15D). Therefore, the Li⁺TFSI⁻ within the QP2VP lamella rapidly diffuses into the transparent sol, causing further contraction of the QP2VP, and the structural color changes to blue (the right schematic of FIG. 4B). It is noteworthy that below the sol-gel transition temperature, the primary factor inducing the contraction of the BCP domain is moisture evaporation. In contrast, above the sol-gel transition temperature, two factors induce the contraction of the domain, further enhancing the blue shift of the structural color.

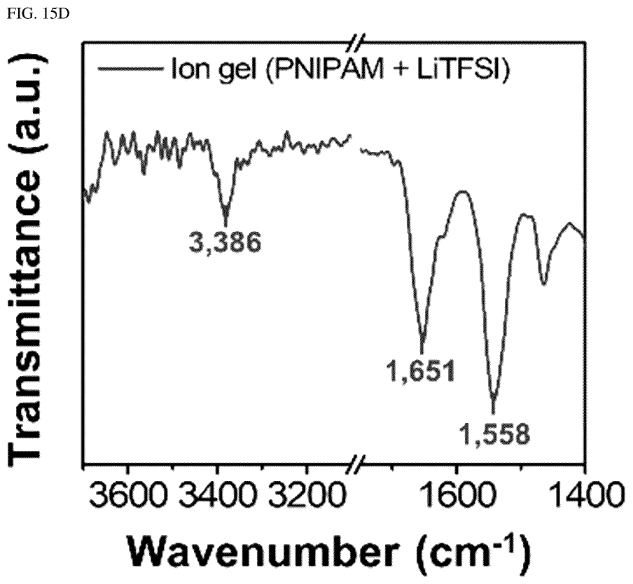

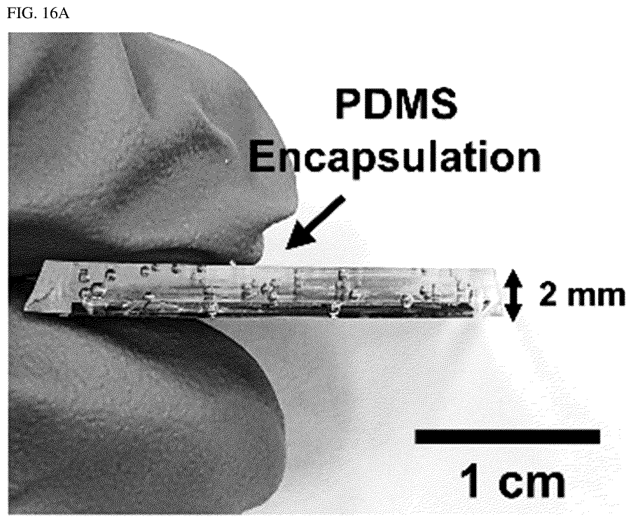

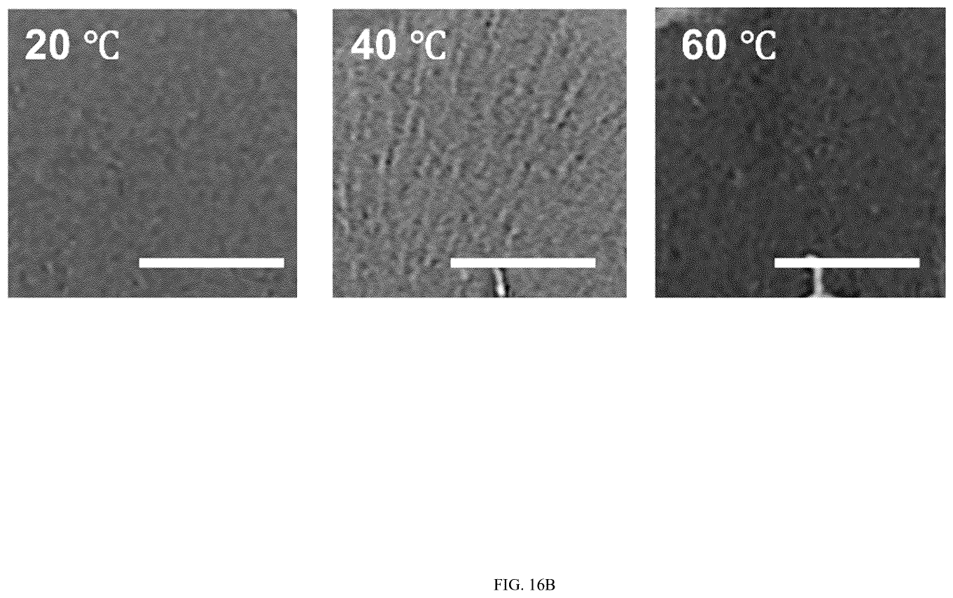

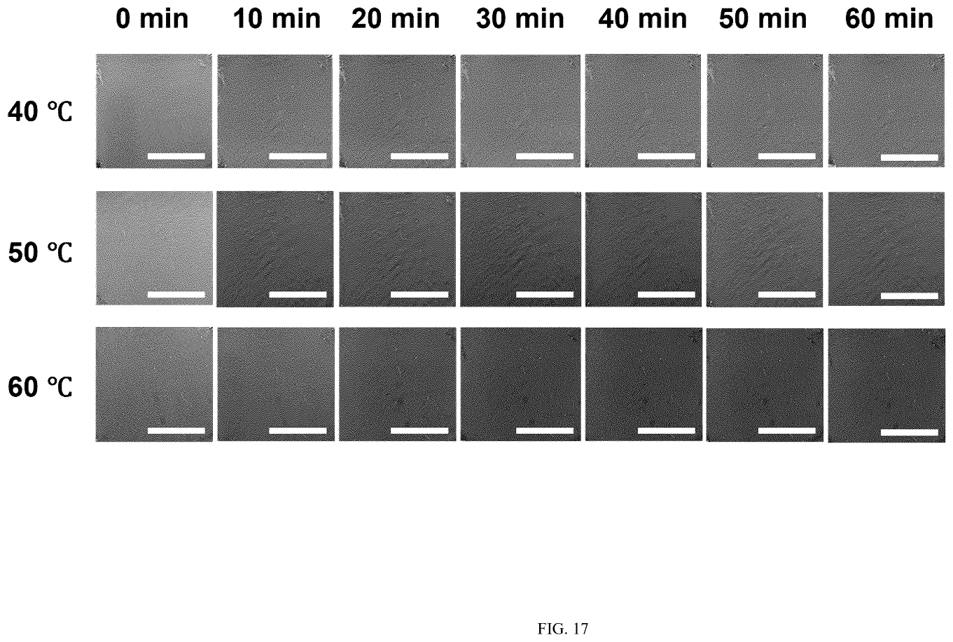

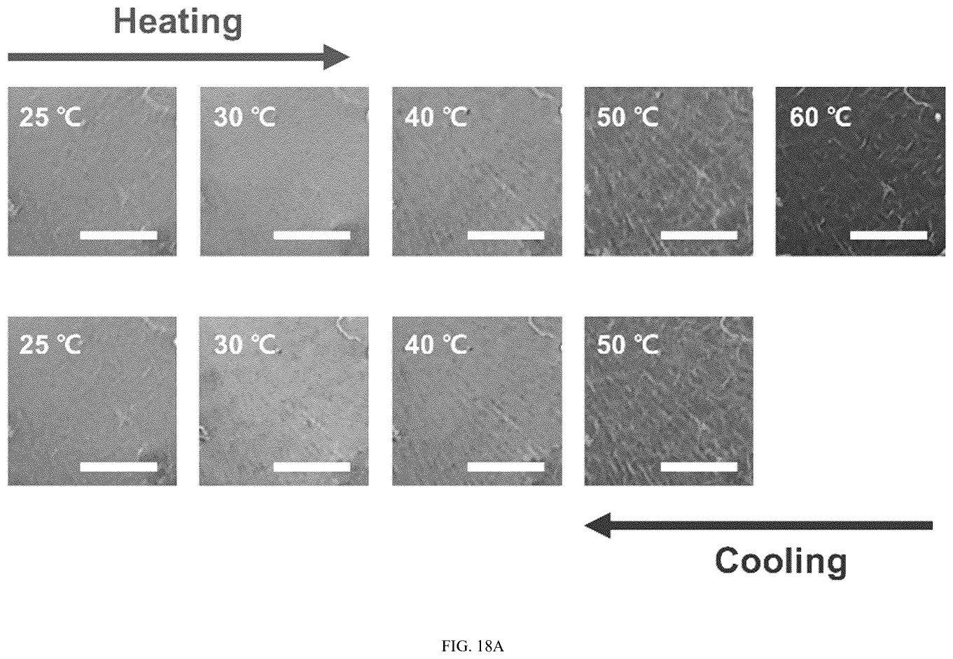

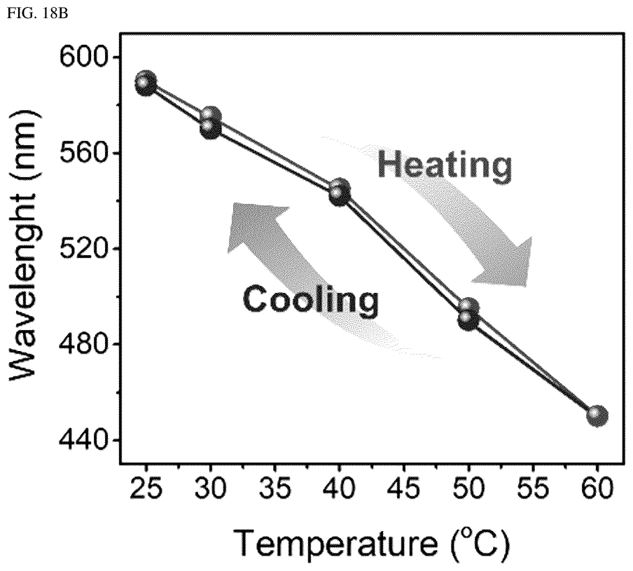

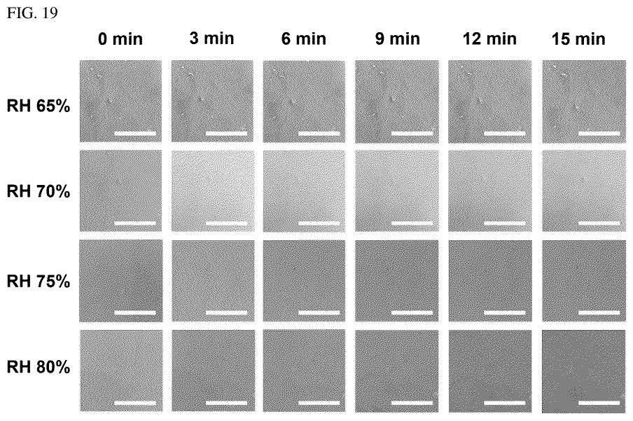

In TADS, the PNIPAM/Li⁺TFSI⁻ ion gel mixed film was prepared by spin coating a mixture of LiTFSI and PNIPAM dissolved in acetonitrile onto the BCP film (refer to the experimental procedure). During the spin coating, the solvent acetonitrile was completely removed from the film. Due to the wettability characteristics of LiTFSI within the film, the spin-coated film easily absorbed moisture. Even when encapsulating the moisture-free device using a poly(dimethylsiloxane) (PDMS) film, the structural color of the BCP photonic crystal changed with temperature according to the movement of LiTFSI molecules inside and outside the BCP film. However, the degree of swelling of the BCP domains caused by LiTFSI was less than the swelling caused by LiTFSI combined with moisture (refer to FIG. 16). In contrast, for the uncapsulated BCP film, the initial structural colors of red, reddish-green, and green at 40°C., 50° C., and 60° C., respectively, shifted to blue due to water evaporation after being exposed for 10 minutes at those temperatures. Subsequently, no significant additional blue shift in structural color occurred in all samples (refer to FIG. 17). Furthermore, during the heating and cooling cycles of the PNIPAM/Li⁺TFSI⁻ mixed film and the stacked BCP photonic crystal film, hysteresis in structural color was hardly observed (refer to FIG. 18). The effect of humidity on the structural color of the BCP photonic crystal was clearly investigated in previous studies. Within the relative humidity range of 30% to 65%, the structural color of the BCP photonic crystal showed little change. However, at high humidity levels above 70%, the structural color of the film shifted slightly to blue (refer to FIG. 19).

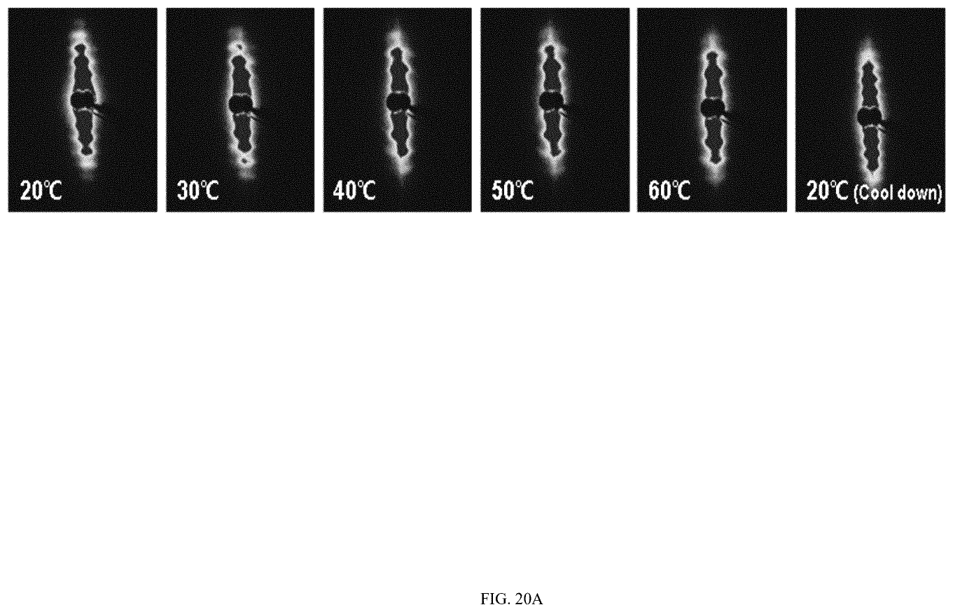

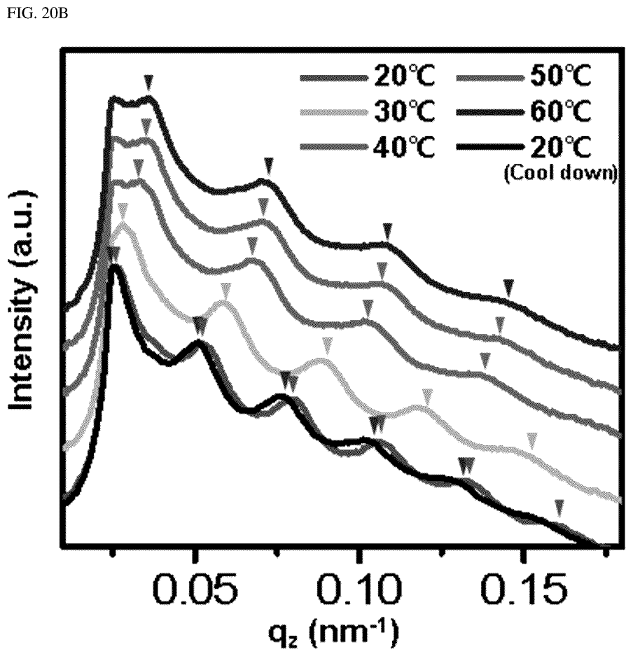

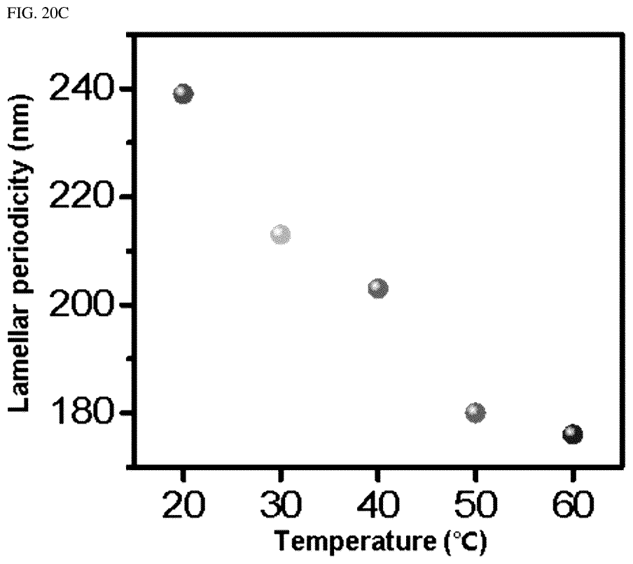

FIG. 4C shows that the wavelength corresponding to the maximum reflectance measured by UV-visible spectroscopy shifts with temperature. This temperature-dependent behavior is consistent with the structural color changes observed in FIG. 4A. These results are further supported by the reflectance results shown in FIG. 14B, which exhibit the same temperature dependence, and are demonstrated by the CIE 1931 color coordinates presented in FIG. 14C. To confirm the correlation between the structural color of TADS and the nanostructure of the BCP photonic crystal, the periodicity of the BCP lamellae with respect to temperature was investigated using grazing incidence small-angle X-ray scattering (GISAXS) (see FIG. 20). FIG. 4D shows the 1D scattering intensity plot of TADS extracted from the 2D SAXS pattern measured at room temperature. Periodic cross lamellae with qn/q1 ratios of 1, 2, 3, and 4 were confirmed. Additionally, from the q1 value (approximately 0.051 nm⁻¹), the periodicity of the lamellae at room temperature was calculated to be approximately 238 nm. The periodicity values at 30° C., 40° C., 50° C., and 60° C. were approximately 213 nm, 203 nm, 180 nm, and 176 nm, respectively, as indicated in FIG. 4C. A nearly identical 1D scattering plot was obtained when the device was cooled to room temperature (FIG. 4D), confirming the reversible structural changes of TADS.

The electrical performance of the BCP layer was evaluated as a function of temperature through electrochemical impedance spectroscopy (EIS), confirming ion migration with respect to temperature within the QP2VP layer (FIG. 4E). The Nyquist plot shows that the semicircle expands as the temperature increases, indicating an increase in bulk resistance represented by the intersection of the real part of the impedance (x-axis) and the semicircle. This is consistent with the results of the temperature-adaptive structural color, suggesting that as Li⁺TFSI⁻ exits the QP2VP lamella of the BCP, the ionic conductivity of the BCP layer decreases.

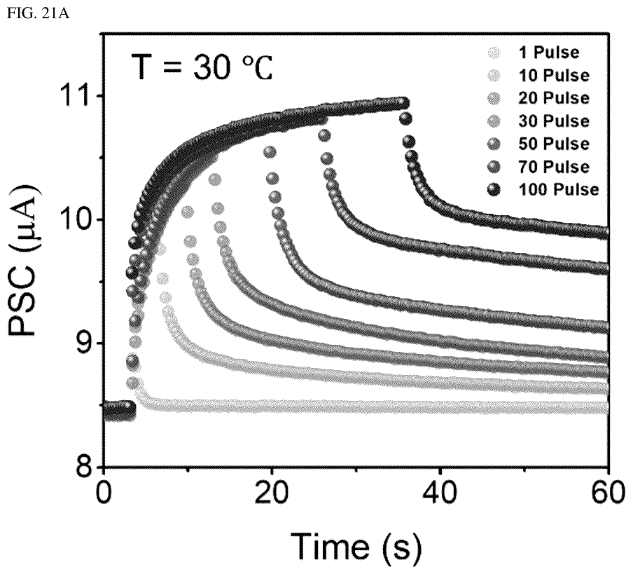

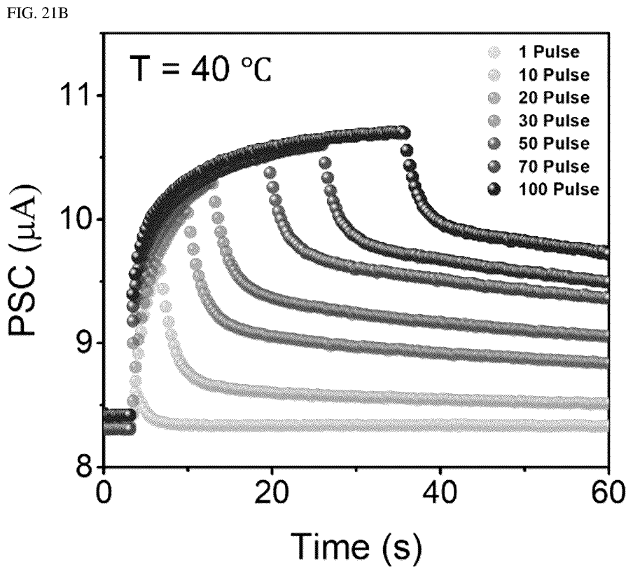

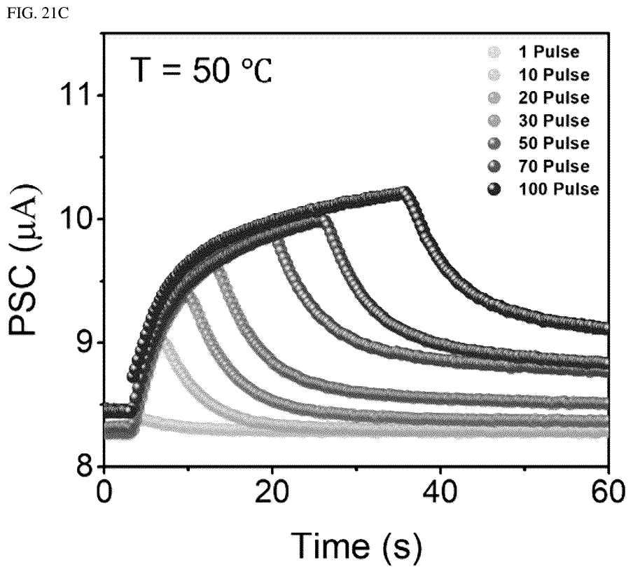

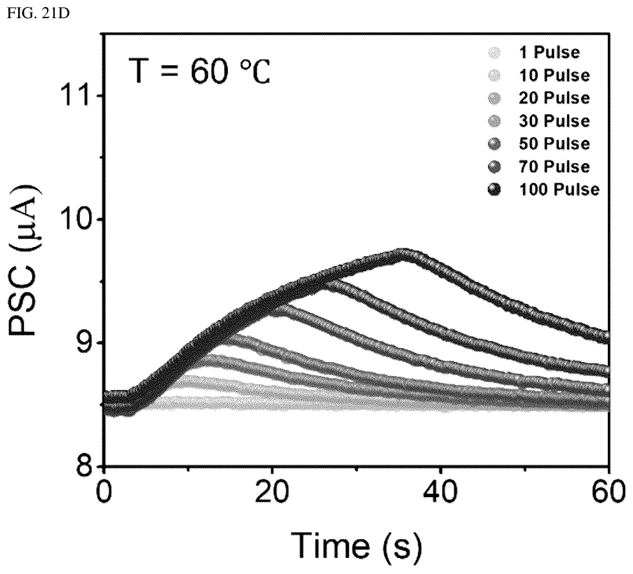

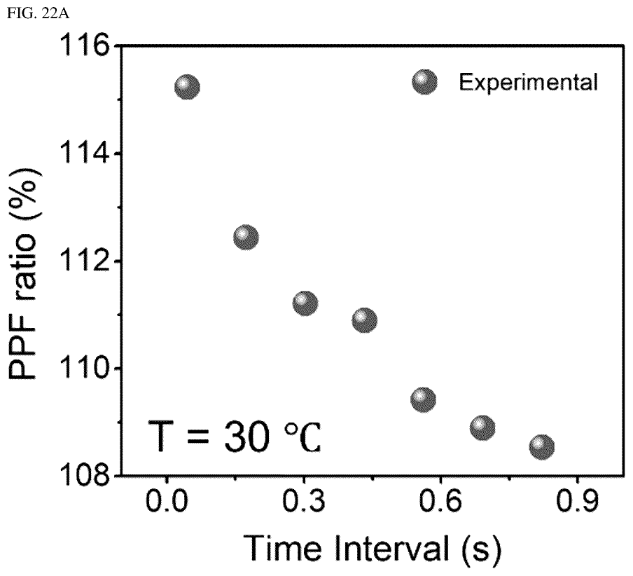

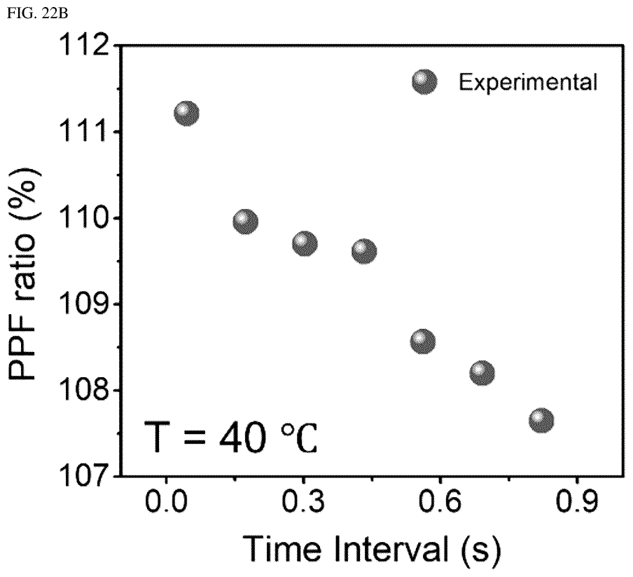

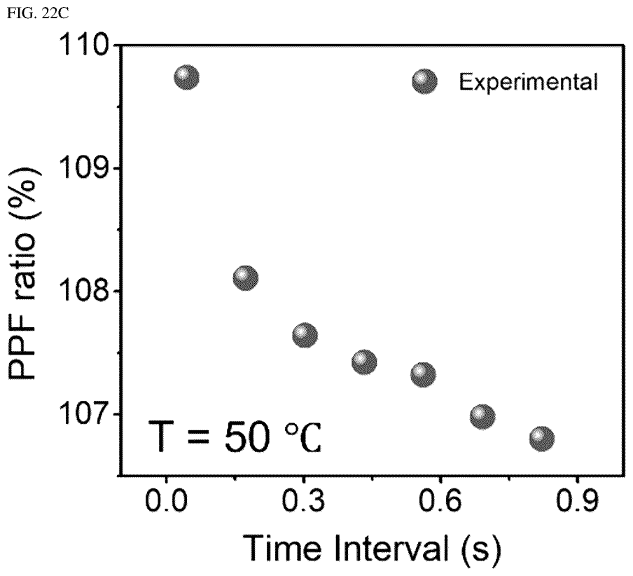

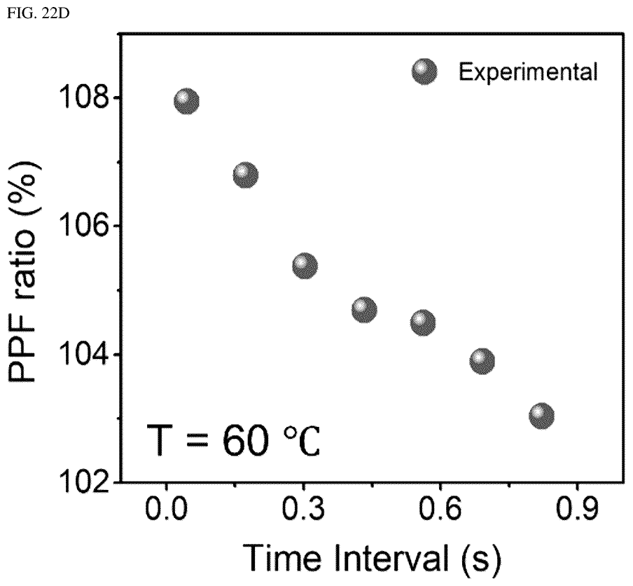

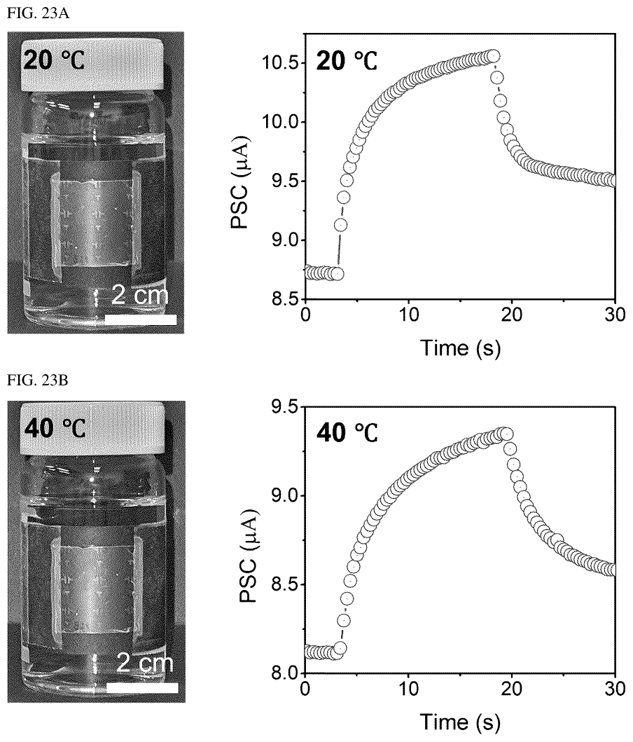

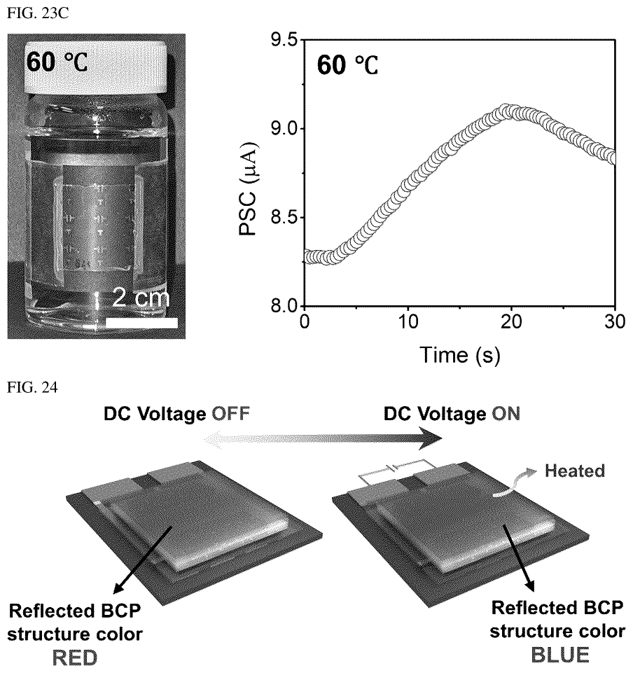

In addition to the temperature-adaptive structural color change of TADS, the temperature-responsive synaptic characteristics were also investigated. FIG. 4F shows that the PSC value gradually decreases over the temperature range from 20° C. to 60° C., with the PSC decreasing from approximately 14.3 μA at 20° C. to approximately 9.1 μA at 60° C. Furthermore, while the PSC value gradually increases with an increasing number of pulses, the overall PSC value and PPF index tend to decrease as the temperature rises from 30° C. to 60° C. (see FIG. 21 and FIG. 22). This is because, as the temperature increases, the ions in the BCP layer move to the Li⁺TFSI⁻/PNIPAM ion gel, resulting in a reduction in the doping amount in the MXene/PEDOT:PSS channel of TADS. These temperature-dependent synaptic characteristics were observed alongside the temperature-adaptive color change occurring in the BCP photonic crystal film of the device. To quantify the effect of temperature on synaptic performance, the ION/IOFF ratio was calculated based on the LTP and LTD currents measured after applying 50 gate pulses at −3 V. As shown in FIG. 4G, the ION/IOFF ratio significantly decreased as the temperature increased: it decreased from 1.69 at 20° C. to 1.56 at 30° C., 1.35 at 40° C., 1.18 at 50° C., and 1.07 at 60° C. Additionally, it was confirmed that the temperature-adaptive synaptic characteristics of TADS are reliable and reversible (see FIG. 4H). The ION/IOFF ratio at specific temperatures was consistently obtained reliably from measurements taken at different temperatures. Moreover, a flexible three-terminal ion gel transistor was fabricated using a transparent polymer substrate, poly(ethylene terephthalate) (PET), and the performance of the device is shown in FIG. 23. Therefore, the temperature-adaptive structural color and synaptic characteristics of TADS enable the development of new temperature-adaptive displays and actuators.

Pixelated TADS Integrated with an Electro-Thermal Converter

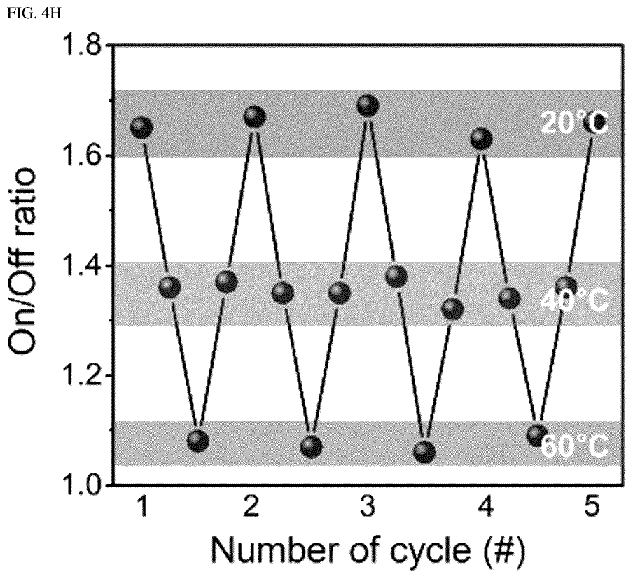

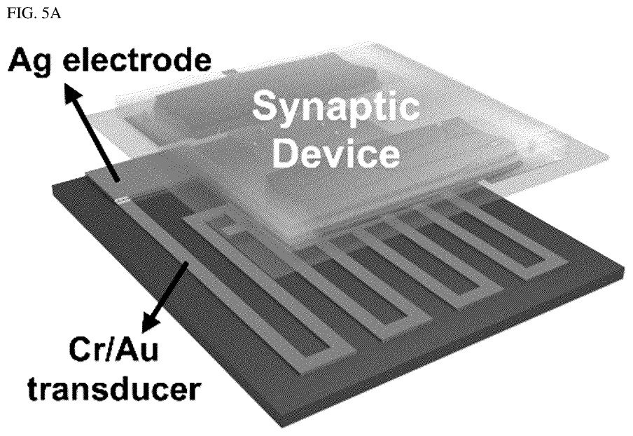

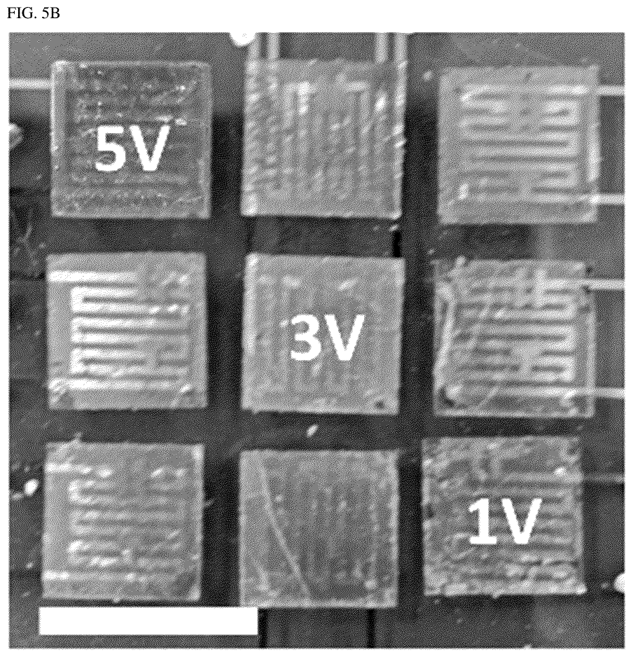

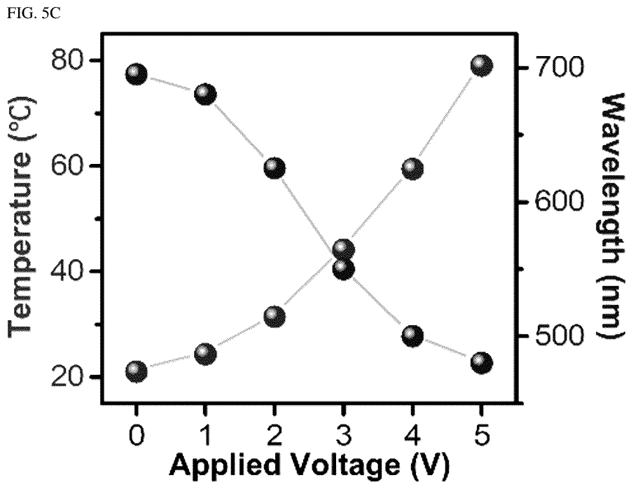

FIG. 5 shows the layout and measurement results of a pixelated TADS integrated with an electro-thermal converter. This system consists of a 3×3 active matrix TADS in which each pixel is combined with an electro-thermal converter, allowing for precise control of the temperature of individual pixels through Joule heating. The electro-thermal converter is fabricated using a thin adhesive chromium (Cr) layer, which supports the TADS structure and provides connectivity through silver (Ag) electrical contacts, as shown in FIG. 5A. This electro-thermal converter can control temperatures from 20° C. to 80° C. by adjusting the applied voltage from 0 to 5 V (FIG. 5B). As expected, the wavelength corresponding to the maximum reflectivity of the TADS shifts with temperature changes. For example, at temperatures of 21° C., 24.3° C., 31.4° C., 44.1° C., 59.4° C., and 79° C., the wavelengths were recorded as 695 nm, 680 nm, 625 nm, 550 nm, 500 nm, and 480 nm, respectively. This temperature-dependent wavelength shift allows for precise control of the structural color of individual TADS pixels using the applied voltage, as demonstrated in FIG. 24. Specifically, pixels [(1,1), (2,2), (3,3)] exhibited blue, green, and red colors at applied voltages of 5 V, 3 V, and 1 V, respectively (FIG. 5C).

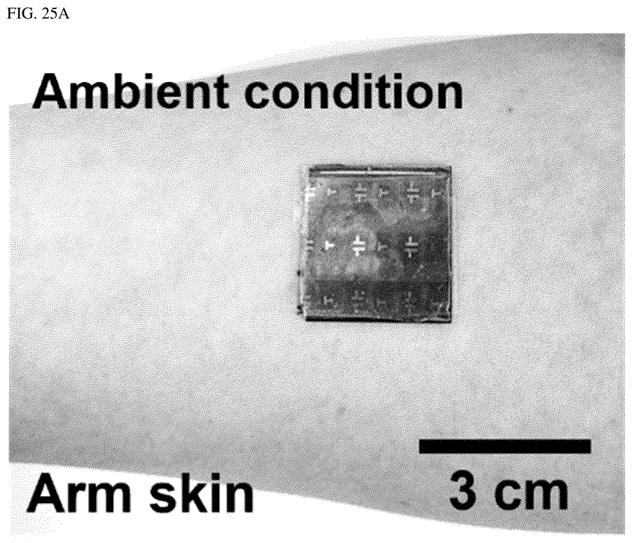

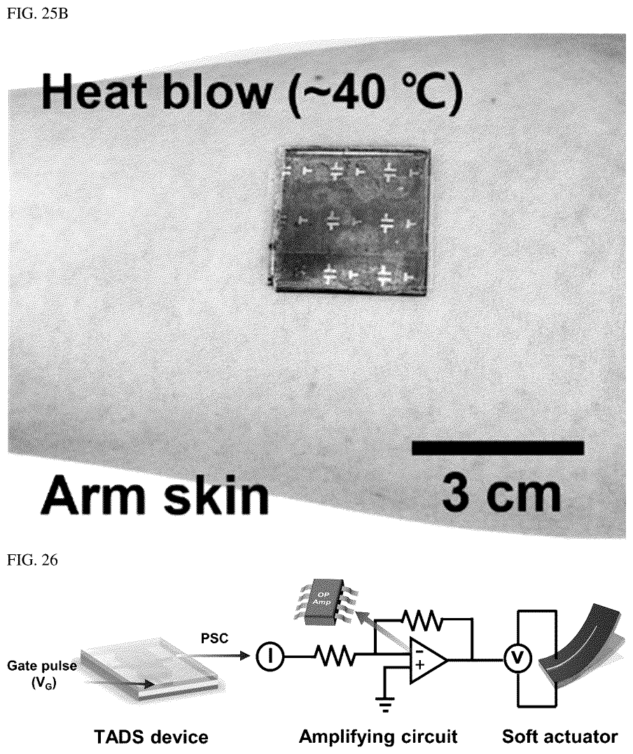

By integrating the active matrix array TADS with the electro-thermal converter, a new rewritable dual-mode information recording system could be developed, as shown in FIG. 5D. Initially, when 0 V was applied across the entire array, all pixels displayed a red structural color with a constant synapse ON/OFF ratio determined at 20° C. (top left of FIG. 5D). When 50 pulses of 3 V were applied at 0.01-second intervals to specific pixels [(1,1), (1,2), (1,3), (2,2), (3,2)], these pixels changed to green, forming a “T” shape (top right of FIG. 5D). This “T” shape was also recognized with the synapse ON/OFF ratio measured at 40° C. The array returned to its initial state, where all pixels exhibited a red structural color (SC) and had a similar ON/OFF ratio at 20° C. and 0 V (bottom right of FIG. 5D). Subsequently, when 50 pulses of 5 V were applied to another set of pixels [(1,1), (2,1), (3,1), (3,2), (3,3)], these pixels changed to blue, forming an “L” shape (bottom left of FIG. 5D). This “L” shape was also recognized with the synapse ON/OFF ratio at 60° C. FIG. 5 clearly illustrates the temperature-dependent synapse characteristics visualized by the temperature-adaptive structural color of the BCP film. In addition to detecting synapse characteristics through current, this device allows for direct visualization of characteristics without external circuit design, enabling the implementation of a new neuromorphic optical skin rather than a neuromorphic electronic skin. In fact, TADS was directly attached to the skin, demonstrating temperature-dependent structural color changes (FIG. 25).

### Temperature-Responsive Neuro-Actuating Photonic Skin (TADS) and Soft Actuator

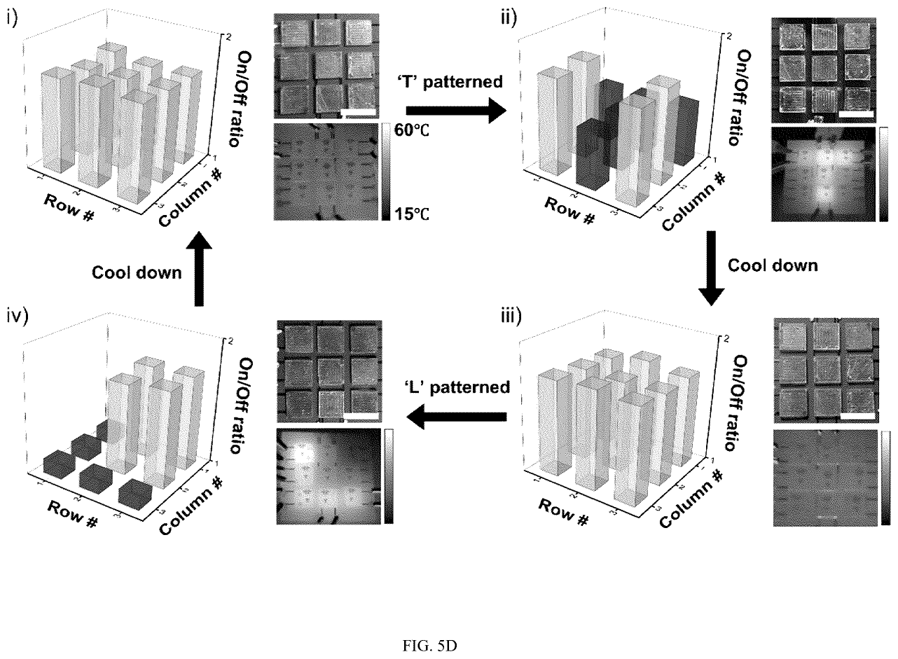

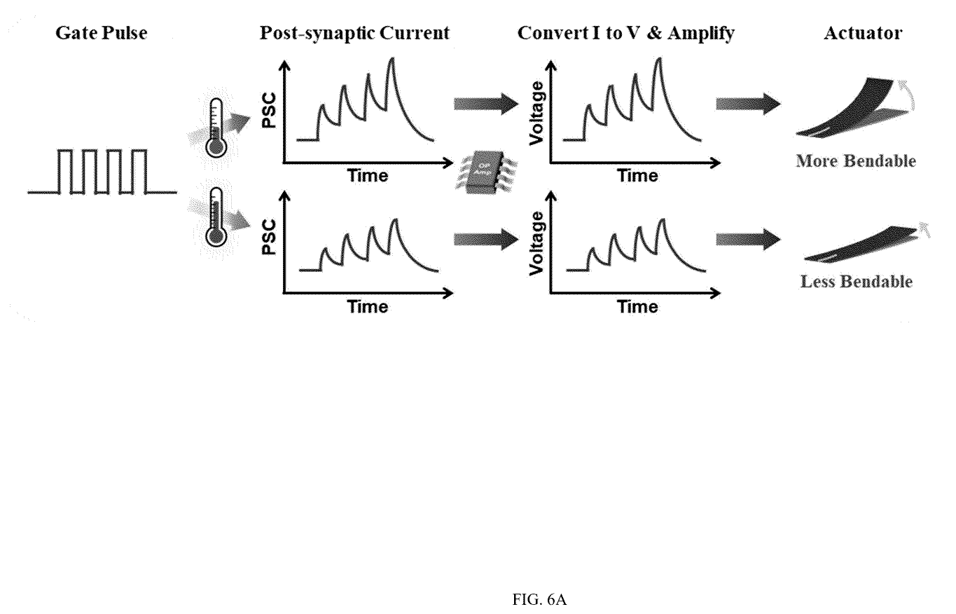

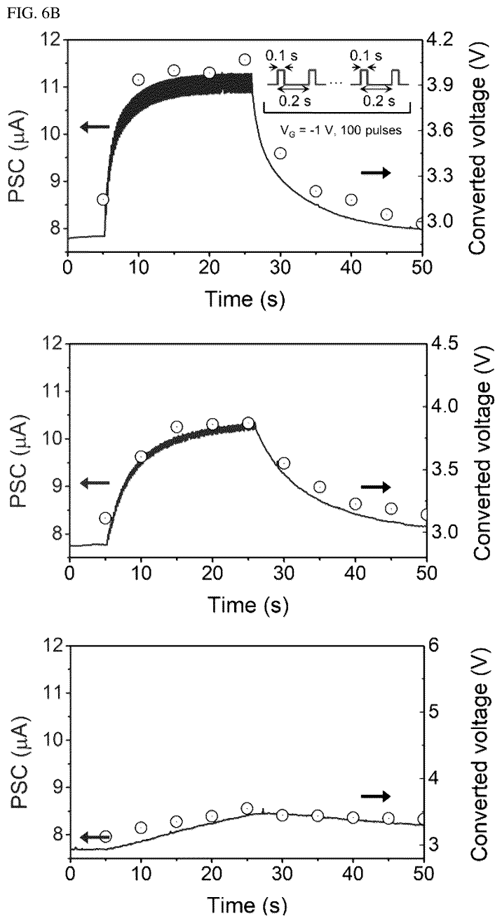

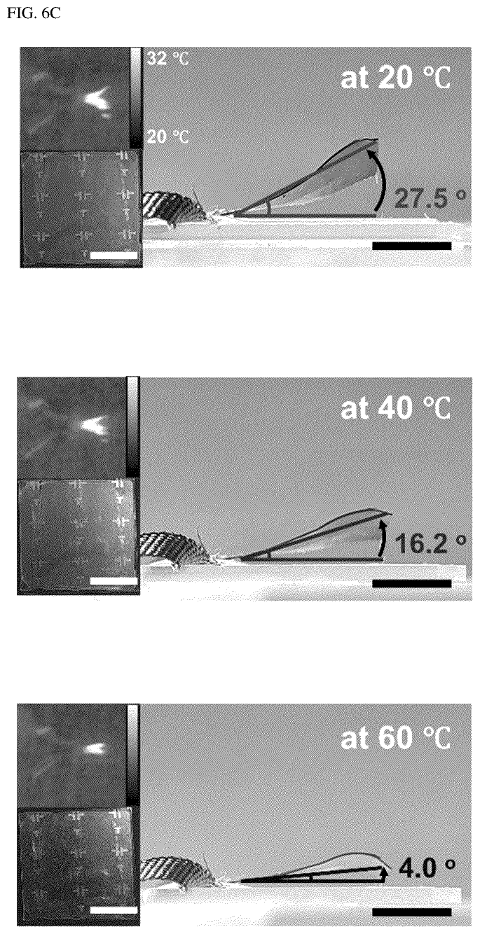

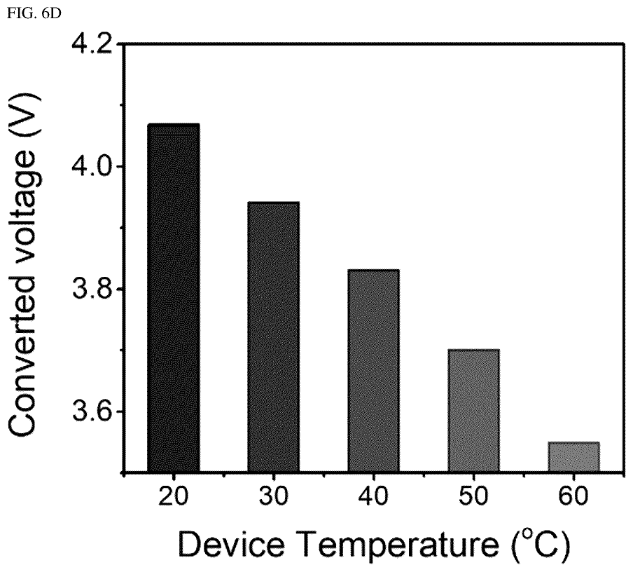

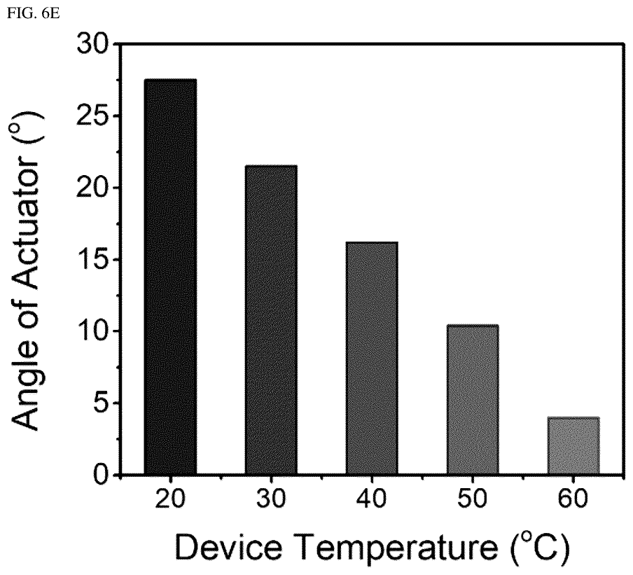

Human muscle movement is controlled through the transmission of pulse-type neural signals. Inspired by this, an artificial somatosensory system with temperature recognition and feedback functions has been developed. This information processing capability is implemented through the connection of TADS and soft actuators, allowing for the control of artificial muscles via temperature changes, as shown in FIG. 6A. The electrically controllable hygroscopic soft actuator is composed of hygroscopic PEDOT:PSS on an elastic PDMS substrate. When a voltage is applied to the conductive PEDOT:PSS, Joule heating occurs in the bilayer actuator. The volume of PEDOT:PSS contracts due to the evaporation of water molecules from the film. Since the PDMS layer remains unchanged after Joule heating, the soft actuator bends to accommodate a robust interface between PEDOT:PSS and PDMS. The degree of bending of the soft actuator can be adjusted from 27.5° to 4.0° by varying the voltage in the range of 4.07 V to 3.55 V.

First, an electrical circuit capable of driving a bilayer soft actuator by converting the postsynaptic current (PSC) generated from TADS at a specific temperature into an amplified voltage was established (FIG. 26). As shown in FIG. 6B, the PSC of TADS generated by 100 gate pulses of −1 V with a pulse length of 0.1 seconds was successfully converted into a voltage value, demonstrating a voltage plot similar to the gate pulse-dependent PSC operation. The long-term potentiation (LTP) current generated from the ion gel transistor in FIG. 6B caused the output voltage to continuously increase rather than the bending angle. The output voltage converted into LTP current through the amplifier was applied to the soft actuator of the present invention. As seen in the top image of FIG. 6C, when the output voltage reached a maximum of 4.07 V, the actuator of the present invention exhibited a bending angle of approximately 27.5°. In particular, three different converted voltage plots were obtained from the PSC results of TADS at 20° C., 40° C., and 60° C. The maximum voltages converted from the PSC results were approximately 4.07 V, 3.83 V, and 3.55 V, respectively, and these voltages were successfully delivered to the bilayer actuator, inducing bending operations of 27.5° at 20° C., 16.2° at 40° C., and 4.0° at 60° C. (see FIG. 6C). The maximum response speed of the soft actuator in the integrated system was approximately 1.37°/s, with a force of about 0.3 μN. The infrared image in FIG. 6C shows the Joule-heated bilayer actuator with different voltages delivered from TADS. As expected, the bilayer actuator reached approximately 50° C. with the voltage converted from the PSC. The Joule heating occurring at 50° C. resulted in the greatest amount of moisture loss in the PEDOT:PSS layer, leading to a maximum bending deformation of about 27.5°. Additionally, it was confirmed that TADS exhibited structural colors of red, green, and blue at 20° C., 40° C., and 60° C., respectively (see the image in FIG. 6C). The voltage converted from TADS and the corresponding bending angles of the bilayer actuator are summarized as a function of temperature in FIG. 6D and FIG. 6E, respectively.

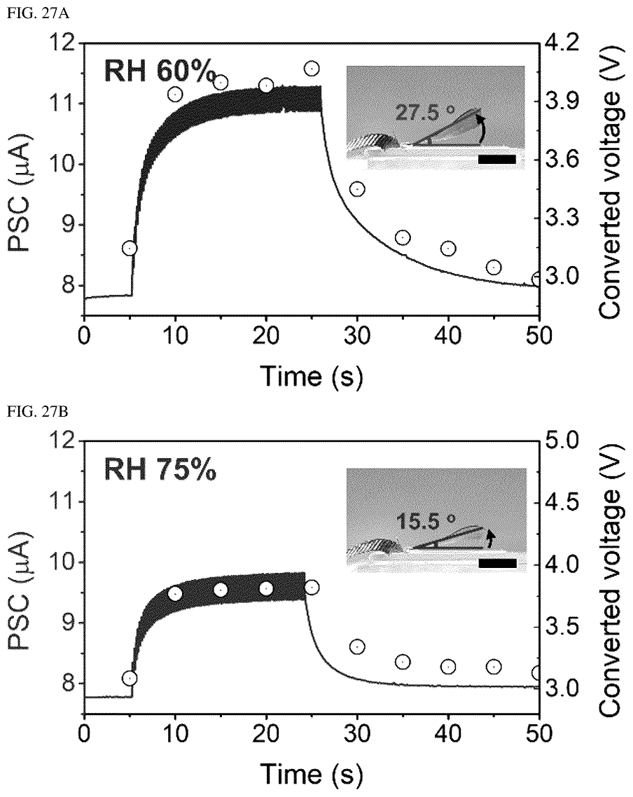

In the actuator of the present invention, a PEDOT:PSS film fully saturated with water is in contact with a PDMS film. When the actuator is heated by the output voltage delivered through the synaptic current, water evaporates from the PEDOT:PSS film, and while the PDMS film remains unchanged, the actuator bends due to the contraction of the PEDOT:PSS film. Relative humidity from 30% to 65% had little effect on the bending operation of the actuator (see FIG. 27A). However, at high humidity levels above 70%, the PSC of the ion gel transistor decreases at high humidity, resulting in a lower converted voltage and a reduced bending angle of the actuator (see FIG. 27B).

FIG. 6 clearly shows that the LTP current is converted into output voltage according to temperature, and this voltage activates the neuro-actuating characteristics of the soft actuator in the TADS. Additionally, the neuro-actuation operation depends on the temperature-sensitive synaptic characteristics. Despite significant progress in the development of integrated synapse devices, there is potential to provide new functionalities such as shape and position recognition, as well as dynamic visual monitoring of stimuli, through color changes in artificial neural skin in response to stimuli. In particular, inspired by various biological systems that enable temperature-adaptive color changes in nature, such as octopuses, chameleons, and spiders, a new temperature-adaptive photonic neural skin has been presented that can not only control synaptic performance according to temperature but also visualize temperature directly. Furthermore, by applying soft actuators to this temperature-adaptive photonic neural skin, it has opened up the possibility of realizing a temperature-adaptive muscle-coupled neural skin with visualization capabilities, providing a platform for human-machine interaction detection displays.

### CONCLUSION

In the present invention, a temperature-responsive photonic neuro-actuating skin that provides synaptic signal transmission, color change, and operational functionality has been implemented. This photonic skin was developed by connecting a temperature-responsive display synapse (TADS) to a soft actuator through a current-amplifying voltage converter. TADS is composed of an ion gel-based MXene/PEDOT:PSS transistor and includes a temperature-responsive BCP PC/PNIPAM/Li⁺TFSI⁻ gate dielectric. This system exhibited structural color changes across the entire visible spectrum generated by the temperature-responsive BCP PC and also demonstrated synaptic characteristics in the MXene/PEDOT:PSS channel at temperatures ranging from 20° C. to 60° C. This study revealed that the structural color and synaptic characteristics of TADS are temperature-dependently controlled by the diffusion of Li⁺TFSI⁻ ions according to the sol-gel transition of PNIPAM/Li⁺TFSI⁻. The reversible and reliable control of the temperature-adaptive structural color and synaptic characteristics of TADS enabled the development of a 3×3 array-based active matrix rewritable information display combined with TADS and a thermoelectric converter, allowing the system to recognize various alphabetic information through structural color and synaptic current. Furthermore, by applying a bilayer soft actuator to TADS, a new temperature-responsive neuro-photonic skin was developed, where the characteristic bending motion of the soft actuator is controlled by the temperature-adaptive synaptic current, while directly visualizing the structural color change of the device. This research presents an artificial intelligence photonic skin with temperature recognition and feedback functionality, demonstrating the potential for multifunctional smart electronic and optoelectronic devices.

### Experimental Method

Materials: Ti3AlC2 MAX powder with a particle size of 40 μm was purchased from Carbon-Ukraine Ltd. (Ukraine) to produce MXene nanosheets. Lithium fluoride (LiF, 98.5%) was obtained from Alfa Aesar (USA). APTES (99%) solution was purchased from Sigma-Aldrich. The aqueous dispersion of PEDOT:PSS (Clevious PH1000) was obtained from Heraeus (Germany). Polydimethylsiloxane (PDMS) base elastomer and curing agent were purchased from Dow Corning Corporation. To fabricate block copolymer photonic crystal (BCP-PC) films, deionized water, polyvinyl alcohol (PVA), propylene glycol methyl ether acetate (PGMEA), chloroform, dibromobutane (DBB), bromoethane (BE), n-hexane, acetonitrile, poly(N-isopropylacrylamide) (PNIPAM) (Mn=85,000 kg mol⁻¹), Lithium bis(trifluoromethanesulfonyl)imide (LiTFSI), and Zonyl-FS300 were purchased from Sigma-Aldrich. PS-b-P2VP was synthesized through living anionic polymerization with an average molecular weight (Mn) of 130 kg mol⁻¹ (Φps=0.51, PDI=1.03).

Preparation of MXene Solution: The Ti3C2 MXene solution was synthesized using a selective chemical etching technique to minimally separate the layers from Ti3AlC2 MAX phase powder, as described in previous studies. First, 3 g of Ti3AlC2 powder was placed in a mild etching solution at 35° C. for 24 hours. This solution was prepared by mixing 4.8 g of LiF and 60 mL of 9M HCl solution in a 250 mL polypropylene plastic bottle. After the reaction was completed, the acidic product dispersion was centrifuged with DI water and washed several times, with each wash conducted at 3500 rpm for 5 minutes. This process was repeated until a stable, concentrated green Ti3C2 flake supernatant with a pH of 5 or higher was obtained. The aqueous dispersion containing the separated Ti₃C₂Tₓ was prepared by adding DI water to the clay-like precipitate and manually shaking it.

BCP PC film production: To prepare a water-soluble sacrificial layer, a 3 wt % PVA solution was dissolved in DI water and spin-coated onto a UV-ozone treated silicon substrate at 1000 rpm for 60 seconds to prepare a PVA film. Subsequently, the film was dried on a hot plate at 100° C. for 10 minutes. To fabricate the BCP thin film, a 7 wt % PS-b-P2VP BCP solution was dissolved in PGMEA and spin-coated onto the PVA film at 500 rpm for 60 seconds, followed by a second spin coating at 2000 rpm for 60 seconds. This film underwent solvent annealing in chloroform vapor for 24 hours on a hot plate at 60° C. Thereafter, the BCP film was immersed in an n-hexane solution containing DBB and BE to selectively convert it into a cation with four covalent bonds. This process partially cross-linked the amine groups within the pyridine rings of the P2VP domains at 60° C. for 24 hours.

TADS fabrication: The Cr(3 nm)/Au(80 nm) electrodes were thermally deposited using a shadow mask on glass substrates sized 8 mm×8 mm and 2.5 cm×2.5 cm. To define the semiconductor channel region, positive photoresist (GXR-601) was spin-coated onto the substrate at 2000 rpm for 30 seconds, followed by baking on a hot plate at 110° C. for 2 minutes. Subsequently, the photoresist was exposed to ultraviolet (UV) light for 10 seconds using a Cr patterned photomask. After exposure, the photoresist was developed for a few seconds in MIF 300 and rinsed with DI water. After drying, the sample underwent O2 plasma treatment at 60 W for 3 minutes, followed by immersion in a 2 vol % APTES solution for 30 minutes to generate NH2 groups. After APTES treatment, a MXene/PEDOT:PSS mixed solution was spin-coated onto the substrate at 800 rpm for 30 seconds, followed by spin-coating at 2000 rpm for 5 seconds. Then, to remove the photoresist covering the MXene/PEDOT:PSS semiconductor channel, the sample was immersed in an ultrasonic bath containing acetone. The sample without photoresist was annealed in a nitrogen-filled glove box at 200° C. for 2 hours. To transfer the BCP PC film to the transistor substrate, the BCP PC film coated with PVA was soaked in DI water for a few minutes to dissolve the PVA layer. Subsequently, the BCP PC film floated on the water and was manually transferred to another substrate. Finally, LiTFSI was added to a 10 wt % PNIPAM solution to prepare the ion gel solution, which was then spin-coated onto the BCP film at 2000 rpm for 60 seconds to expand the BCP PC film.

Development of a soft actuator integrated with TADS: A PDMS film was prepared by mixing a basic elastomer and a curing agent in a weight ratio of 10:1, followed by spin coating on a silicon wafer at 500 rpm for 60 seconds and curing at 95° C. for 1 hour. Subsequently, the film was treated with oxygen plasma for 60 seconds. To fabricate the actuator, a PEDOT:PSS dispersion containing 1 wt % Zonyl-FS300 was spin-coated 12 times on the plasma-treated PDMS substrate, with each layer coated at 2000 rpm for 60 seconds. Each layer was annealed at 170° C. for 5 minutes in ambient air and underwent oxygen plasma treatment for 10 seconds. The final heat treatment was conducted at 170° C. for 1 hour, and conductive fibers were attached to the actuator using silver paste. To integrate the TADS system with the soft actuator, the source-drain circuit of the TADS device was connected to an amplification circuit, and the output was connected to the PEDOT:PSS/PDMS soft actuator.

Characterization Analysis: The cross-sectional structure of TADS was analyzed using FIB-SEM (Helios 5 UC, FEI) and TEM (JEM-F200, JEOL). Additionally, the elemental distribution within the structure was analyzed using EDS with FIB-SEM. The chemical bonding between MXene and PEDOT:PSS was analyzed using XPS (AXIS Supra+, Kratos, U.K.) and FT-IR (INVENIO R, Bruker). Furthermore, changes between MXene layers were confirmed using HR-XRD (SmartLab, Rigaku) based on Bragg's equation. The reflection and transmission spectra of the BCP PC film coated on a glass substrate were recorded using a UV-vis spectrophotometer (V-650, Jasco). The thermal phase transition of the ion gel transistor was observed using DSC (DSC 8000, Perkin Elmer) at a heating rate of 5°C./min from 25° C. to 60° C. The self-assembled nanostructured domains of the BCP film were characterized using Grazing-incidence small-angle scattering (GISAXS) at the PLS-II 9 A U-SAXS beamline of the Pohang Accelerator Laboratory. The impedance of the PNIPAM/Li⁺TFSI⁻ layer was measured in the range of 1 Hz to 1 MHz using EIS equipment (VMP2, Biologic). Synaptic characteristics were analyzed using a semiconductor characterization system (4200-SCS, Keithley Instruments Inc.) by applying various gate voltages and pulse times.

Although the above has been described with reference to preferred embodiments of the present invention, those skilled in the art will understand that various modifications and changes can be made to the present invention without departing from the spirit and scope of the invention as set forth in the following patent claims.

What is claimed is:

1. A temperature-responsive transistor-actuator device comprising:
a transistor part comprising:
(a) a semiconductor layer;
(b) a block copolymer layer formed on the semiconductor layer and having a lamella structure;
(c) an ion gel layer formed on the block copolymer layer;
(d) a source electrode contacting the semiconductor layer;
(e) a drain electrode spaced apart from the source electrode and contacting the semiconductor layer; and
(f) a gate electrode spaced apart from the source electrode and the drain electrode, and applying a voltage to the semiconductor layer;
a converter part electrically connected to the source electrode or the drain electrode; and
an actuator part electrically connected to the converter part and having a bilayer structure of materials having different degrees of contraction according to moisture content.

2. The temperature-responsive transistor-actuator device according to claim 1,
wherein the semiconductor layer comprises PEDOT:PSS and MXene.

3. The temperature-responsive transistor-actuator device according to claim 2,
wherein PEDOT:PSS and MXene included in the semiconductor layer have a weight ratio of 2:1 to 4:1.

4. The temperature-responsive transistor-actuator device according to claim 3,
wherein the on-off ratio of the semiconductor layer is 1.6 to 1.8.

5. The temperature-responsive transistor-actuator device according to claim 1,
wherein the block copolymer layer comprises poly(styrene-block-2-vinylpyridine) (PS-b-P2VP).

6. The temperature-responsive transistor-actuator device according to claim 1,
wherein the ion gel layer comprises poly(N-isopropylacrylamide) (PNIPAM) and lithium bis(trifluoromethanesulfonyl)imide (Li⁺TFSI⁻).

7. The temperature-responsive transistor-actuator device according to claim 1,
wherein the bilayer structure of the actuator part comprises a first layer including PDMS and a second layer including PEDOT:PSS,
and when moisture evaporates due to Joule heat generated by a voltage applied to the second layer, the bilayer is bent in the direction of the second layer.

8. The temperature-responsive transistor-actuator device according to claim 7,
wherein the bilayer structure of the actuator part has the second layer formed only on a portion of the first layer.

9. A method of manufacturing a temperature-responsive transistor-actuator device, comprising:
(a) a semiconductor layer forming step of forming, on a substrate, a semiconductor layer; a source electrode contacting the semiconductor layer; and a drain electrode spaced apart from the source electrode and contacting the semiconductor layer;
(b) a BCP forming step of forming a block copolymer layer having a lamella structure on the semiconductor layer;
(c) an ion gel forming step of forming an ion gel layer on the block copolymer layer; and
(d) a converter connecting step of preparing an actuator part having a bilayer structure and electrically connecting the actuator part to the source electrode or the drain electrode via a converter part;
and further comprising a gate electrode forming step of forming a gate electrode capable of applying a voltage to the semiconductor layer.

10. The method of manufacturing a temperature-responsive transistor-actuator device according to claim 9,
wherein the semiconductor layer comprises PEDOT:PSS and MXene,
and PEDOT:PSS and MXene included in the semiconductor layer have a weight ratio of 2:1 to 4:1.

11. The method of manufacturing a temperature-responsive transistor-actuator device according to claim 9,
wherein the block copolymer layer comprises poly(styrene-block-2-vinylpyridine) (PS-b-P2VP).

12. The method of manufacturing a temperature-responsive transistor-actuator device according to claim 9,
wherein the ion gel layer comprises poly(N-isopropylacrylamide) (PNIPAM) and lithium bis(trifluoromethanesulfonyl)imide (Li⁺TFSI⁻).

13. The method of manufacturing a temperature-responsive transistor-actuator device according to claim 9,
wherein the bilayer structure of the actuator part is prepared to comprise a first layer including PDMS and a second layer including PEDOT:PSS.

14. The method of manufacturing a temperature-responsive transistor-actuator device according to claim 13,
wherein the bilayer structure of the actuator part is formed such that the second layer is formed only on a portion of the first layer.

15. The method of manufacturing a temperature-responsive transistor-actuator device according to claim 14,
wherein the bilayer structure of the actuator part is formed by stacking the first layer and the second layer and then removing a portion so as to partially block conductive paths formed in the second layer, thereby extending the length of the conductive paths.
